(19) United States
(12) Patent Application Publication
(10) Pub. No.: US 2005/0163313 A1
(43) Pub. Date: Jul. 28, 2005

(54) Methods and apparatus for parallel implementations of table look-ups and ciphering

(76) Inventors: Roger Maitland, Woodlawn (CA); Mark Turnbull, Stittsville (CA)

Correspondence Address: SMART & BIGGAR/FETHERSTONHAUGH & CO.;P.O. BOX 2999, STATION D, 900-55 METCALFE STREET, OTTAWA, ON, K1P5Y6, CA

(21) Appl. No.: 10/762,364

(22) Filed: Jan. 23, 2004

(51) Int. Cl. H04K 1/00

(52) U.S. Cl. 380/28

(57) ABSTRACT

A method and apparatus are used to generate outputs according to a ciphering algorithm which for each of the outputs operates on a respective input using a respective key. The ciphering algorithm has a plurality of rounds in which functions are evaluated. For a least one of the functions, outputs are generated by looking up at least one look-up table with each look-up table being looked-up in parallel using respective inputs. Different methods for parallel table look-up are provided. The methods allows the ciphering algorithm to be implemented partially or entirely in parallel. An example parallel implementation involves the Kasumi algorithm in which S7 and S9 functions are evaluated in parallel for a plurality of inputs using vector instructions on an SIMD (Single Instruction Multiple Data) architecture.

### FIELD OF THE INVENTION

The invention relates to a method and apparatus for parallel implementations of table look-ups. For example, the invention relates to a parallel implementation of table look-ups in the context of a Kasumi algorithm for Ciphering (Encryption) in communications networks.

### BACKGROUND OF THE INVENTION

In networks, for example a UMTS (Universal Mobile Telecommunications System) network, a Kasumi ciphering algorithm has been used for ciphering, which is also known as Encryption. In particular, data being transmitted is ciphered for transmission. Referring to FIG. 1, shown is block diagram of a ciphering block 100 operating on input data 140 being transmitted at for example an RNC (Radio Network Controller) in a UMTS network (not shown). The ciphering block 100 implements a Kasumi ciphering algorithm that produces a 64-bit output 130 from a 64-bit input 110 under the control of a 128-bit key 120. The input data 140 undergoes an exclusive-OR operation 150 using the output 130 from the ciphering block 100 resulting in ciphered data 160. In particular, the Kasumi algorithm is a Feistel cipher as shown in FIGS. 2A to 2D with eight rounds in which a number of functions are evaluated at each of the eight rounds. The functions of each of the eight rounds are described in detail in a document entitled “KASUMI Specification” available at http://www.3gpp.org/TB/other/algorithms/35202-311.pdf, which is incorporated herein by reference. In particular, at each of the eight rounds two of the functions referred to as an S7 function and an S9 function are each evaluated 6 times. The S7 function maps a 7-bit input X defined by bits x₁ (i=0 to 6), to a 7-bit output Y defined by bits yⱼ (j=0 to 6). The S9 function maps a 9-bit input X′ defined by bits x′ₖ (k=0 to 8), to a 9-bit output Y′ defined by bits y′ₗ (l=0 to 8).

For the S7 function, the output Y is a function of X. Equivalently, each bit yⱼ is a function of the bits xᵢ as given by Equations 200, 201, 202, 203, 204, 205, 206 shown in FIG. 3. In Equations 200, 201, 202, 203, 204, 205, 206, xₘxₙ (m, n=0 to 6) is written as a short form for xₘ∩xₙ where ∩ is an AND operator. Similarly, in Equations 200, 201, 202, 203, 204, 205, 206, xₘxₙxₒ (o=0 to 6) is written as a short form for xₘ∩xₙ∩xₒ. Finally, in Equations 200, 201, 202, 203, 204, 205, 206, ⊕ is an exclusive-OR operator.

For the S9 function the output Y′ is a function of X′. Equivalently, each of the bits y′₁ is a function of the bits x′ₖ as given by Equations 300, 301, 302, 303, 304, 305, 306, 307, 308 shown in FIG. 4. In Equations 300, 301, 302, 303, 304, 305, 306, 307, 308, x′ₚx′_{q} (p, q=0 to 8) is written as a short form for x′ₚ∩x′_{q}. Similarly, in Equations 300, 301, 302, 303, 304, 305, 306, 307, 308, x′ₚx′_{q}x′ᵣ (r=0 to 8) is written as a short form for x′ₚ∩x′_{q}∩x′ᵣ.

The Kasumi algorithm including evaluation of the S7 and S9 functions have not been implemented in parallel for multiple inputs. Since most of the computing in the Kasumi algorithm involves evaluating the S7 and S9 functions, the non-parallel implementation for evaluating these functions imposes considerable limitations in efficiency.

Some non-parallel implementations have been developed using software written in assembly language; however, CPU (Central Processing Unit) resources required by the: Kasumi algorithm are still limiting.

### SUMMARY OF THE INVENTION

A method and apparatus are used to generate outputs according to a ciphering algorithm which for each of the outputs operates on a respective input using a respective key. The ciphering algorithm has a plurality of rounds in which functions are evaluated. For a least one of the functions, outputs are generated by looking up at least one look-up table with each look-up table being looked-up in parallel using respective inputs. Different methods for parallel table look-ups are provided. The methods allows the ciphering algorithm to be implemented partially or entirely in parallel.

One parallel implementation involves the Kasumi algorithm in which S7 and S9 functions are evaluated in parallel for a plurality of inputs using vector instructions on an SIMD (Single Instruction Multiple Data) architecture. In some implementations, the methods of looking up look-up tables make use of look-up tables which can be pre-loaded in their entirety into vectors. For example, in one implementation a PowerPC is employed having an Altivec co-processor having 32 vectors each capable of holding a number of elements. A method provides a parallel implementation of the Kasumi algorithm in which the S7 and S9 functions are each looked up in parallel for a plurality of inputs. The method employs Look-up tables for the S7 and S9 functions which are pre-loaded in their entirety into the 32 vectors for look-ups using vector instructions. Such a parallel implementation provides processing that is approximately 6 to 8 times faster than existing non-parallel Kasumi implementations.

According to a broad aspect, the invention provides a method in which there is a plurality of inputs, each input being defined by a first set of bits and a second seat of one or more bits. For each input of the plurality of inputs and in parallel with other inputs of the plurality of inputs the method involves for each of a plurality of look-up tables each having a plurality of elements, looking-up one of the plurality of elements of the look-up table using the first set of bits that define the input to obtain an output. The output from each of the plurality of look-up tables collectively form a set of corresponding outputs. For each input and in parallel with the other inputs a corresponding output from the set of corresponding outputs is then selected using the second set of one or more bits that defines the input.

According to another broad aspect, the invention provides an apparatus having a processor and a memory adapted to store a plurality of elements of each of a plurality of look-up tables. The processor receives a plurality of inputs, each input being defined by a first set of bits and a second set of one or more bits. For each input of the plurality of inputs and in parallel with other inputs of the plurality of inputs the processor is adapted to for each of the plurality of look-up tables, look-up one of the plurality of elements of the look-up table using the first set of bits that define the input to obtain an output. For each input, the output from each of the plurality of look-up tables collectively form a set of corresponding outputs. For each input and in parallel with the other inputs the processor is also adapted to select a corresponding output from the set of corresponding outputs using the second set of one or more bits that define the input.

According to another broad aspect, the invention provides a method in which there is a plurality of inputs each defined by a first plurality of bits. For each input of the plurality of inputs and in parallel with other inputs of the plurality of inputs, the method involves for each of a plurality of look-up tables each having a plurality of elements: (i) selecting a respective subset of bits of the first plurality of bits that define the input, the bits of the respective subset of bits having fewer bits than the first plurality of bits of the input; and (ii) looking-up an element of the plurality of elements of the look-up table using the subset of bits to obtain an output. For each input and in parallel with the other inputs, the method also involves combining the outputs obtained from the plurality of look-up tables to obtain at least one bit.

According to another broad aspect, the invention provides an apparatus having a processor and a memory adapted to store a plurality of elements of each of a plurality of look-up tables. There is a plurality of inputs each defined by a first plurality of bits. For each input of the plurality of inputs and in parallel with other inputs of the plurality of inputs, the processor is adapted to for each hook-up table: (i) select a respective subset of bits of the first plurality of bits that define the input, the bits of the respective subset of bits having fewer bits than the first plurality of bits of the input; and (ii) look-up an element of the plurality of elements of the look-up table using the subset of bits to obtain an output. For each input and in parallel with the other inputs the processor is also adapted to combine the outputs obtained from the plurality of look-up tables to obtain at least one bit.

According to another broad aspect, the invention provides a method which in response to N Kᵢₙ-bit inputs performs bit permutation/reordering on the N Kᵢₙ-bit inputs to produce M parallel sets of outputs wherein N and Kᵢₙ are integers satisfying N, Kᵢₙ≧2. An ith set of outputs of the M parallel sets of outputs contains N sets of bits L_{i,in} bits in length with i and L_{i,in} being integers satisfying i=l to M and 1≦L_{i,in}<Kᵢₙ. The ith set of outputs defines a respective subset of the Kin bits of the inputs. For each parallel set of outputs, a parallel lookup table operation is performed to generate a corresponding parallel set of outputs containing N outputs, each being associated with a respective one of the N Kᵢₙ-bit inputs and each being L_{i,out} bits in length. L_{i,out} is an integer satisfying L_{i,out}≧1. For each of the N Kᵢₙ-bit inputs, a respective output is generated by performing a bit combining operation on the outputs from the parallel look-up table operations associated with the input.

According to another broad aspect, the invention provides a method of generating a plurality of outputs according to a ciphering algorithm which for each of the plurality of outputs operates on a respective input using a respective key. The ciphering algorithm has a plurality of rounds in which functions are evaluated. For at least one function of the functions of at least one of the plurality of rounds there is a plurality of first inputs each being associated with one of the respective inputs. For each first input and in parallel with other first inputs of the plurality of first inputs, the method involves generating an output by looking up at least one look-up table using the input, each look-up table having a plurality of elements.

In some embodiments of the invention, the ciphering algorithm is a Kasumi algorithm.

According to another broad aspect, the intention provides an apparatus for generating a plurality of outputs according to a ciphering algorithm which for each of the plurality of outputs operates on a respective input using a respective key. The ciphering algorithm has a plurality of rounds in which functions are evaluated. The apparatus has a processor and a memory adapted to store a plurality of elements of each of at least one look-up table. For at least one function of the functions of at least one of the plurality of rounds, the processor is adapted to: responsive to a plurality of first inputs each being associated with one of the respective inputs, for each first input and in parallel with other first inputs of the plurality of first inputs generate an output by looking up at least one look-up table using the input, each look-up table having a plurality of elements.

In some embodiments of the invention, the ciphering algorithm is a Kasumi algorithm.

According to another broad aspect, the invention provides a method for which there is a plurality of inputs, each input being defined by one or more bits. For each input of the plurality of inputs and in parallel with other inputs of the plurality of inputs the method involves looking-up, a look-up table having a plurality of elements using the one or more bits that define the input to obtain an output.

According to another broad aspect, the invention provides an apparatus having a processor and a memory adapted to store a plurality of elements of a look-up table. There is a plurality of inputs, each input being defined by one or more bit. For each input of the plurality of inputs and in parallel with other inputs of the plurality of inputs the processor is adapted to look-up the look-up table using the one or more bits that define the input to obtain an output.

### BRIEF DESCRIPTION OF THE DRAWINGS

Preferred embodiments of the invention will now be described with reference to the attached drawings in which:

FIG. 1 is block diagram of a ciphering block operating on input data being transmitted at for example an RNC (Radio Network Controller) in a UMTS (Universal Mobile Telecommunications System) network;

FIG. 2A is a flow chart for the Kasumi algorithm;

FIG. 2B is a flow chart of an FO function evaluated at each terminal of the Kasumi algorithm of FIG. 2A;

FIG. 2C is a flow chart of an FI function evaluated for the FO function of FIG. 2B;

FIG. 2D is a flow chart of an FL function evaluated for the FI function of FIG. 2A;

FIG. 3 is a list of Equations for an S7 function of a Kasumi algorithm;

FIG. 4 is a list of Equations for an S9 function of the Kasumi algorithm;

FIG. 5 is a flow chart of a method of performing parallel look-ups using tables, according to an embodiment of the invention;

FIG. 6 is a flow diagram of elements being looked up in look-up tables and selected according to the method of FIG. 5 as applied to an S7 function;

FIG. 7 is a block diagram of vectors being operated on during a vperm (vector permutation) instruction;

FIG. 8 is a flow chart of a method of performing a step in the method of FIG. 5;

FIG. 9 is a flow chart of a method of selecting an output from two other outputs in method steps of FIG. 8;

FIG. 10 is a block diagram of a vector being operated on during a vsel (vector select) instruction used in method step of FIG. 9;

FIG. 11 is a flow chart of a method of performing parallel look-ups using tables, according to another embodiment of the invention;

FIG. 12 is a table listing into groups components x′ₚx′_{q} of Equations of FIG. 4 that are to undergo an exclusive-OR operation, in accordance with another embodiment of the invention;

FIG. 13 is a table listing for each group, of FIG. 12, input bits used as indices into look-up tables and output bits returned by the look-up tables;

FIG. 14 is a table listing for each group, ordering of the input bits listed in FIG. 13;

FIG. 15A is a block diagram of a vector being operated on during a vsrb (vector shift right byte) instruction used in method steps of FIG. 11;

FIG. 15B is a block diagram of vectors being operated on during a vsel instruction used in method steps of FIG. 11;

FIG. 15C is a block diagram of a vector being operated on during a vrlb (vector rotate left byte) instruction used in method steps of FIG. 11;

FIG. 15D is a block diagram of vectors being operated on during a vsel instruction used in method steps of FIG. 11;

FIG. 15E is a block diagram of vectors being operated on during vslb (vector shift left byte) and vsel instructions used in method steps of FIG. 11;

FIG. 15F is a block diagram of vectors being operated on during vsrb and vsel instructions used in method steps of FIG. 11;

FIG. 16 is a block diagram of vectors being operated on during a vperm instruction used in method steps of FIG. 11;

FIG. 17 is flow chart of a method of combining outputs obtained in a step of FIG. 11;

FIG. 18 is a flow diagram showing how vectors containing outputs are combined by being operated on using exclusive-OR and bit manipulation operations;

FIG. 19A is a block diagram of an apparatus for implementing the methods of FIGS. 5 and 11;

FIG. 19B is a block diagram of the apparatus of FIG. 19A implemented as a ciphering block; and

FIG. 20 is an operation flow diagram of an example implementation of a method of looking up tables in parallel.

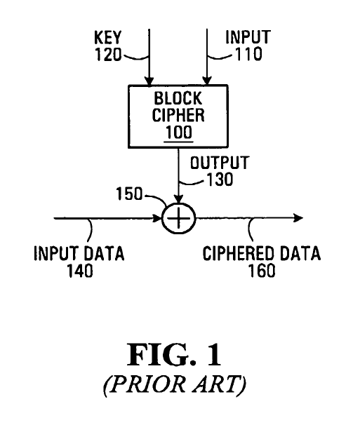

### DETAILED DESCRIPTION OF THE PREFERRED EMBODIMENTS

In a ciphering algorithm an input is operated on using a key to generate an output. Input data is then combined with the output to produce ciphered data. In the ciphering algorithm there are a plurality of rounds in which functions are evaluated. Some of these functions cannot be implemented in a simple manner for parallel computation on a number of inputs to generate a number of outputs in parallel. In some embodiments of the invention a method of generating a plurality of outputs according to such ciphering algorithms is implemented at least partially in parallel for a number of inputs and keys. In some embodiments of the invention, the ciphering algorithm is implemented entirely in parallel. Furthermore, in some embodiments of the invention the outputs obtained are combined, in parallel, with input data to generate ciphered data using, for example, exclusive-OR operations implemented in parallel.

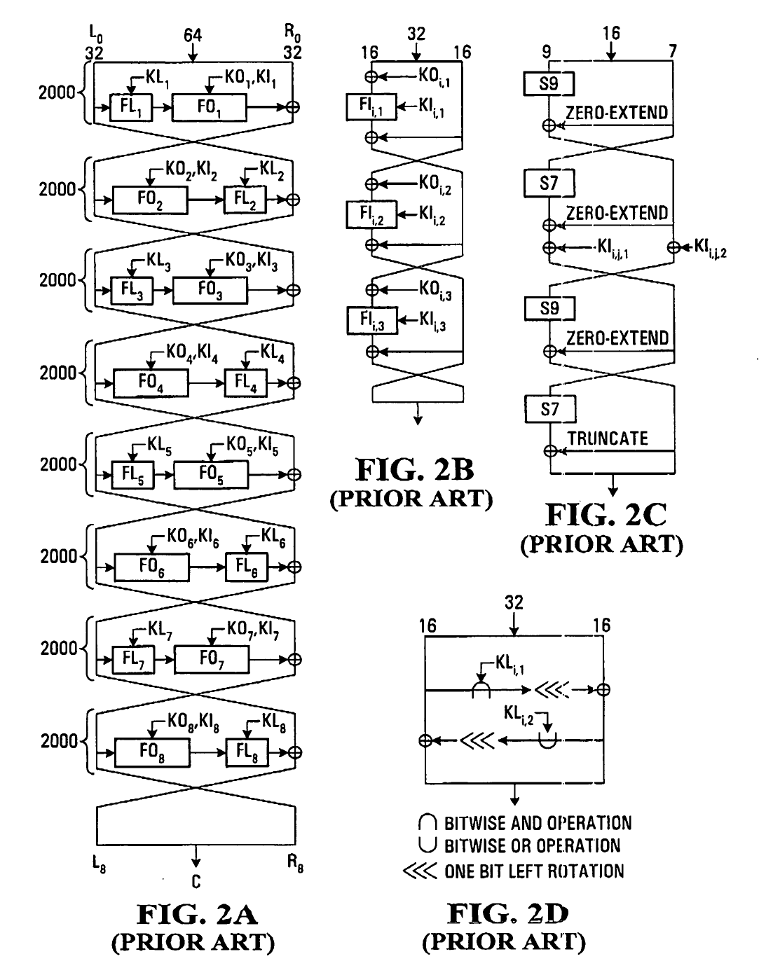

A parallel implementation of a Kasumi algorithm will be described as an illustrative example; however, it is to be clearly understood that the invention is not limited to a parallel implementation of the Kasumi algorithm and in other embodiments of the invention other ciphering algorithms are implemented in parallel. In order to describe a parallel implementation of the Kasumi algorithm, it is worthwhile to first look at the Kasumi algorithm with reference to FIGS. 2A to 2D. The Kasumi algorithm has eight rounds 2000 of computations and at each round 2000 a number of functions are performed including FOᵢ and FLᵢ (i=1 to 8) functions, FI_{i,g} (g=1 to 3) functions, S7 and S9 functions, exclusive-OR operations shown as ⊕, zero-extend operations, truncate operations, bitwise AND operations shown as ∩, bitwise OR operations shown as ∪, and one-bit left rotation operations shown as <<<. The S7 and S9 functions can be evaluated using look-up tables each containing pre-determined elements.

In some embodiments of the invention the Kasumi algorithm is implemented in parallel for a plurality inputs and keys to generate a plurality of outputs wherein functions of the algorithm are evaluated in parallel. In some embodiments, the algorithm is implemented entirely in parallel wherein each function of the algorithm is implemented in parallel while in other embodiments the algorithm is implemented partially in parallel wherein at least one function of at least one of the rounds 2000 is implemented in parallel. Furthermore, as discussed above, the invention is not limited to the Kasumi algorithm and in other embodiments of the invention, other ciphering algorithms are implemented in parallel.

More generally, in some embodiments of than invention, a method is used to generate a plurality of outputs according to a ciphering algorithm which for each of the plurality of outputs operates on a respective input using a respective key. The ciphering algorithm has a plurality of rounds in which functions are evaluated. At least one of the functions of at least one of the rounds is evaluated in parallel. In particular, for a plurality of first inputs each being associated with one of the respective inputs, and in parallel with the other first inputs, the method involves generating an output by looking-up at least one look-up table using the first input wherein each look-up table has a plurality of elements. In other words, each look-up table is looked-up in parallel using the first inputs. Different methods of performing table look-ups in parallel will be described below. For the Kasumi algorithm, the parallel table look-ups might be used for any one or more of the S7 and S9 functions, for example. In some embodiment of the invention, other functions of the Kasumi algorithm such as the FOᵢ and FLᵢ (i=1 to 8) functions, FI_{i,g} (g=1 to 3) functions the exclusive-OR operations shown as ⊕, zero-extend operations, truncate operations, bitwise AND operations shown as ∩, bitwise OR operations shown as ∪, and one-bit left rotation operations shown as <<< are evaluated in parallel using vector instruction available on SIMD (Single Instructions Multiple Data) architectures.

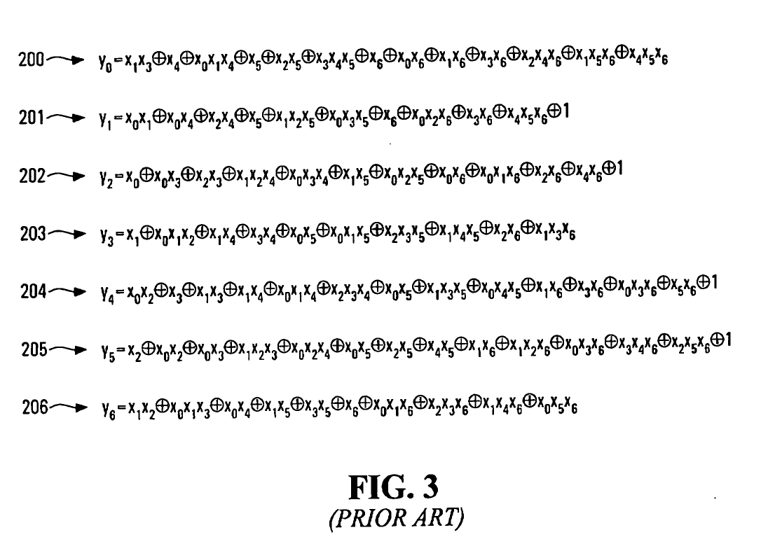

A major part of the Kasumi algorithm consists of evaluating the S7 and S9 functions. The Kasumi algorithm is adaptable for implementation on a SIMD (Single Instruction Multiple Data) architecture such as that of a well known PowerPC processor having an Altivec co-processor, in which vector instructions are used to operate vectors and perform parallel computations on the data; however, the S7 and S9 functions are not well suited for simple implementation on SIMD architectures. In particular, for a conventional evaluation of the S7 function of FIG. 3 an output Y with bits yⱼ (j=0 to 6) is made using tables with 2⁷=128 7-bit elements. Similarly, for the S9 function an output Y′ wits, bits y′ₖ (k=0 to 8) is evaluated using tables with 2⁹=512 9-bit elements. For a conventional evaluation of the S9 function, the table requires 9-bit elements because the input X′ and the output Y′ both have 9 bits. For a parallel implementation on a PowerPC processor having an Altivec co-processor, the look-up tables for both S7 and the S9 functions are too large to fit in a vector that is looked up using a single vector instruction. For example, for a PowerPC processor having an Altivec co-processor a vperm (vector permutation) instruction can be used to look-up tables. For the vperm instruction, a look-up table can be loaded into one or two vectors each capable of holding 16 1-byte elements; however, the look-up tables for the S7 and the S9 functions have 128 and 512 elements, respectively. Therefore, the tables cannot fit in the one or two vectors used by the vperm instruction. Furthermore, for a PowerPC processor having an Altivec co-processor, there are 32 vectors each having 128 bits. As such, a maximum of 32 16-byte elements, for example, can be loaded into the vectors and therefore the look-up table for the S9 function cannot be loaded its entirety for look-ups.

In some embodiments of the invention, for the S7 and S9 functions specialized tables are used to perform parallel look-ups. The use of the specialized tables allow:s the S7 and S9 functions to be evaluated in parallel using it few instructions and this allows the Kasumi algorithm to be applied in parallel on for example a SIMD (Simple Instruction Multiple Data) architecture to achieve a high performance.

As a broad introduction to methods of performing look-ups in parallel, a method will now be described and then as an illustrative example the method will applied to the S7 function of the Kasumi algorithm. Similarly, another method will be described and then an illustrative example of the other method will be applied to the S9 function.

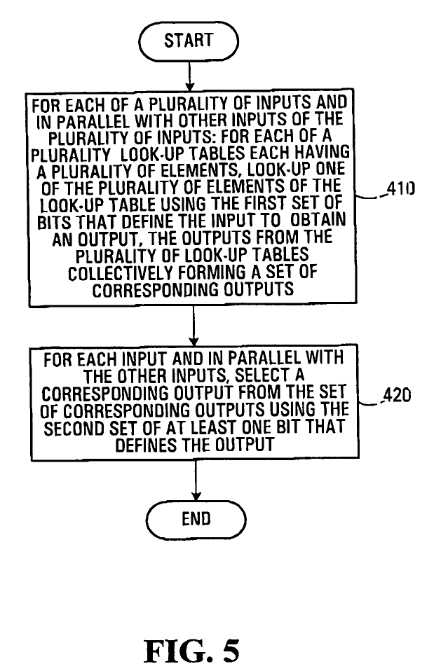

Referring to FIG. 5, shown is a flow chart of a method of performing parallel look-ups using tables, according to an embodiment of the invention. The method takes as inputs two or more inputs X_{I} and outputs two or more outputs Y_{J}. The inputs are each defined by a first set of bits and a second set of one or more bits. A function that maps the inputs X_{I} onto the outputs Y_{J} is represented by two or more tables each having a plurality of elements for look-up by the first set of bits of each of the inputs X_{I}. At step 410, for each input X_{I} and in parallel with other inputs X_{I} one of the elements of each look-up table is looked up using the first subset of bits that define the input to obtain-outputs. It is to be understood that each table is looked up in parallel using the first subset of bits of each input. For each input X_{I}, the outputs collectively form a set of corresponding outputs. At step 420, for each input X_{I} and in parallel with the other inputs, a corresponding output of the set of corresponding outputs is selected using the second set of one or more bits that define the input X_{I}. Again it is to be understood that, at step 420 the selection is made in parallel with other selections for other inputs, X_{I}.

As an illustrative example, the method of FIG. 5 will now be applied for evaluating the S7 function of the Kasumi algorithm with reference being made to FIGS. 3 and 6 to 10. It is to be clearly understood that what follows is only one example implementation falling in the broad language of FIG. 5.

As shown by Equations 200 to 206 in FIG. 3, the S7 function has X as an input and has Y as an output with X and Y being defined by 7 bits xᵢ and yⱼ, respectively. As such, in applying the method of FIG. 5 to evaluate the S7 function, X_{I}=X, and Y_{J}=Y. Since the input X has 7 bits xᵢ, there are 2⁷=128 possible values for Y in evaluating the S7 function. In the illustrated embodiment of the invention, each possible value for Y is pre-determined and stored in a memory as one of 27=128 elements. The 128 elements form look-up tables and for each input X, the elements from the look-up tables are looked-up and then one of the elements is selected.

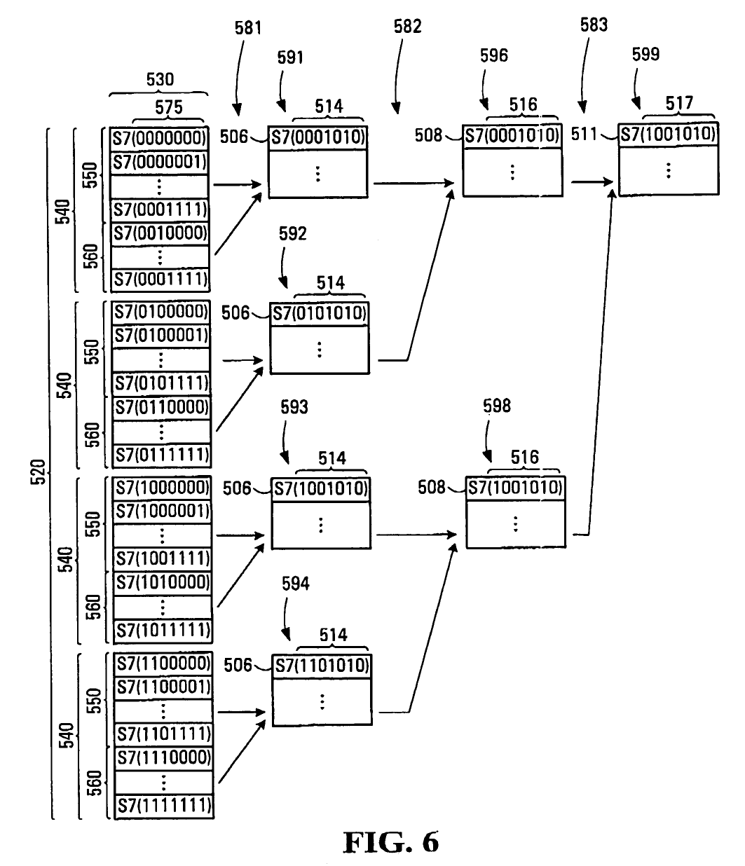

In FIG. 6, shown is a flow diagram of elements being looked up in look-up tables and selected according to the method of FIG. 5 as applied to the S7 function. In particular, the flow diagram of FIG. 6 is used to illustrate the method steps 410, 420 of FIG. 5 for a specific input X.

In FIG. 6, the 128 elements are shown as elements 520 (only 20 elements 520 are shown for clarity). Each element 520 has a pre-determined value 530 shown as S7 (x₆x₅x₄x₃x₂x₁x₀) which is a function of a bit sequence 575 x₆x₅x₄x₃x₂x₁x₀=0000000 to 1111111 as given by the S7 function of FIG. 3. In the method of FIG. 5, for each input X, one of the elements 520 is selected depending on a value the input X is carrying. As such, for purposes of illustrating how one of the elements 520 is selected, for each input X the values for the bit sequences 575 are explicitly shown as numbers rather than having the pre-determined values 530 being shown explicitly.

In the illustrative example, the method of FIG. 5 is implemented on a PowerPC processor having an Altivec co-processor. A respective vperm (vector permutation) instruction is used at step 410 for performing look-ups in each look-up table and vsel (vector select) instructions are used at step 420 to select a corresponding output for each input X.

Further details of this particular embodiment will be described both generally and with reference to a specific input value for X=x₆x₅x₄x₃x₂x₁x₀=1001010 in base-2 notation, which corresponds to X=74 in base-10 notation.

A single vperm instruction, as described in detail below, can be used to operate on inputs vectors vA(e_{1,a}, . . . ,e_{16,a}), vB(e_{1,b}, . . . ,e_{16,b}) using a vector vC(e_{1,c}, . . . ,e_{16,c}) with each of these sectors having 2⁴=16 1-byte elements e_{w,a}, e_{w,b}, and e_{w,c} (w=1 to 16), respectively. The vperm instruction return a vector vD(e_{1,d}, . . . ,e_{16,d}) having 2⁴=16 1-byte elements e_{w,d}. In particular, for each element e_{w,d} of the vector vD(e_{1,d}, . . . ,e_{16,d}) one of the elements e_{w,a} of the vector vA(e_{1,a}, . . . ,e_{16,a}) and the elements e_{w,b} of the vector vB(e_{1,b}, . . . ,e_{16,b}) is selected using 5 bits of a respective one of the 1-byte elements e_{w,c} of the vector vC(e_{1,c}, . . . ,e_{16,c}). Alternatively, in other embodiments of the invention, a single vperm instruction can be used to operate on the vector vA(e_{1,a}, . . . ,e_{16,a}) using vector vC(e_{1,c}, . . . ,e_{16,c}) and return the vector vD(e_{1,d}, . . . ,e_{16,d}), wherein for each element e_{w,d} of the vector vD(e_{1,d}, . . . ,e_{16,d}) one of the elements e_{w,a} of the vector vA(e_{1,a}, . . . ,e_{16,a}) is selected using 4 bits of a respective one of the 1-byte elements e_{w,c} of the vector vC(e_{1,c}, . . . ,e_{16,c}).

In the illustrative example, the vperm instruction is used to operate on vectors vA(e_{1,c}, . . . ,e_{16,a}), vB(e_{1,b}, . . . ,e_{16,b}) using vector vC(e_{1,c}, . . . ,e_{16,c}) each having the 16 1-byte elements e_{w,a}, e_{w,b}, and e_{w,c}, respectively. In particular, the vperm instruction operates on 16 elements of a 32-element look-up table that is loaded as vector vA(e_{1,b}, . . . ,e_{16,a}) and another 16 elements of the 32-element look-up table that is loaded as vector vB(e_{1,b}, . . . ,e_{6,b}) with the 16 inputs X being loaded as vector vC(e_{1,c}, . . . ,e_{16,c}).

Recall with reference to FIG. 5, that each input X has a first set of bits and a second set of bits. There is a respective look-up table for each permutation of the second set of bits. In other words, all elements of a given look-up table will contain Y values determined for a set of X values sharing a common second set of bits.

For the example of FIG. 6, each X input is 7 bits, and has a 5-bit first set of bits and a 2-bit second set of bits. The first set consists of the least significant bits while the second set consists of the most significant bits. There is a respective look-up table for each permutation of the second set of bits, in this case requiring four look-up tables 540 each containing 2⁵⁼³² elements. Each look-up table 540 has portions 550, 560 each having 16 elements 520 to be operated on by the vperm instruction as vectors vA(e_{1,a}, . . . ,e_{16,a}) and vB(e_{1,b}, . . . ,e_{16,b}), respectively.

A step 581 in the flow diagram of FIG. 6 is illustrative of step 410 of FIG. 5 wherein for each input X, one element 520 is looked-up for each look-up table 540 to obtain outputs. Outputs from the look-up tables 540 from step 410 are shown as groups of outputs 591, 592, 593, 594 with each group of outputs 591, 592, 593, 594 having 16 outputs (only one output in each group of outputs 591, 592, 593, 594 is shown for clarity). Outputs from the groups of outputs 591, 592, 593, 594 form sets of corresponding outputs. For example, outputs 506 from the groups of outputs 591, 592, 593, 594 form a set of corresponding outputs. Each output of the groups of outputs 591, 592, 593, 594 has a pre-determined value S⁷(x₆x₅x₄x₃x₂x₁x₀) which is a function of a bit sequence 514 and for each set of corresponding outputs the bit sequences 514 have the same 5 least significant bits but different 2 most significant bits, For the example input with X=x₆x₅x₄x₃x₂x₁x₀=1001010, the bit sequences 514 of corresponding outputs 506 all have the same 5 least significant bits 01010 but different 2 most significant bits 00, 01, 10, 11.

Step 420 of FIG. 5, in which for each input X, a corresponding output of the set of corresponding outputs is selected is shown as a two step process in the flow diagram of FIG. 6. In a first selection 582, a group of outputs 596 is selected from groups of outputs 591, 592 and a group of outputs 598 is selected from groups of outputs 593, 594. The groups of outputs 596, 598 each have 16 outputs (only one output 508 is shown in each group of outputs 596, 598 for clarity). Outputs from the groups of outputs 596, 598 form sets of corresponding outputs. For example, outputs 508 from the groups of outputs 596, 598 form a set of corresponding outputs. Each output of the groups of outputs 596, 598 has a pre-determined value S7 (x₆x₅x₄x₃x₂x₁x₀) which is a function of a bit sequence 516 and for each set of corresponding outputs the bit sequences 516 have the same 6 least significant bits but a different most significant bit. For the example input with X=x₆x₅x₄x₃x₂x₁x₀=1001010, the bit sequences 516 of corresponding outputs 508 both have the same 6 least significant bits 001010 but different most significant bits 0, 1. In a second selection 583, a group of outputs 599 is selected from the groups of outputs 596, 598 with the groups of outputs 599 having 16 outputs (only one output 511 is shown in the group of outputs 599 for clarity). Each output of the group of outputs 599 has a pre-determined value S7 (x₆x₅x₄x₃x₂x₁x₀) which is a function of a bit sequence 517 that corresponds to a respective input X. For example, the bit sequence 517 of output 511 has a value that corresponds to the example input X=x₆x₅x₄x₃x₂x₁x₀=1001010.

In the illustrative example, each of the 16 inputs X has 7 bits xᵢ of which there is the first set of bits having 5 least significant bits x₄x₃x₂x₁x₀ and the second set of bits having 2 most significant bits x₆x₅. For our specific example, the input has a value X=x₆x₅x₄x₃x₂x₁x₀=1001010 in base-2 notation with the order of significance from most significance to least significance being from left to right. The first set of bits for the input corresponds the 5 least significant bits 01010 of X=x₆x₅x₄x₃x₂x₁x₀=1001010 and the second set of bits for the input correspond the 2 most significant bits 10 of X=x₆x₅x₄x₃x₂x₁x₀=1001010.

At step 410 of FIG. 5, for each look-up table 540 the vperm instruction is used to perform a look-up in the look-up table 540 using the first set of bits of each of 16 inputs X. Thus four vperm instructions are used to look-up the four look-up tables 540.

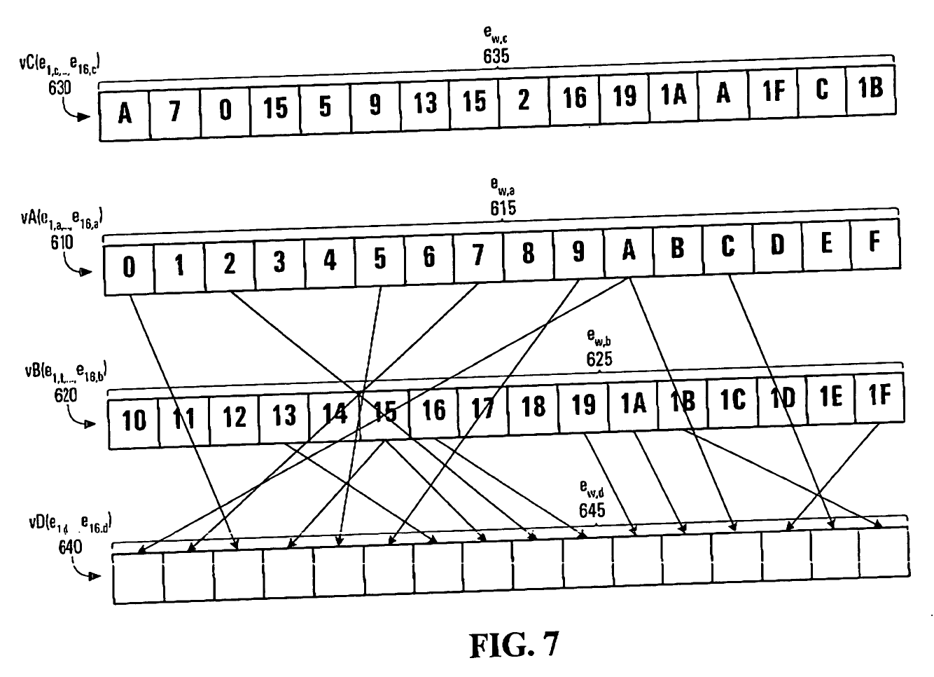

The vperm instruction will now be described with reference to FIGS. 6 and 7. In FIG. 6, the look-up tables 540 are shown each having portion 550 and portion 560. At step 410, for each look-up table 540 a vperm instruction operates on vectors vA(e_{1,a}, . . . ,e_{16,a}) 610 and vB(e_{1,b}, . . . ,e_{16,b}) 620 using vector vC(e_{1,c}, . . . ,e_{16,c}) 630 to return a vector vD(e_{1,d}, . . ,e_{16,d}) 640. The vectors vA(e_{1,c}, . . . ,e_{16,a}) 610 and vB(e_{1,b}, . . . ,e_{16,b}) 620 contain elements 520 from the portions 550 and 560, respectively, of the look-up table 540 being looked-up, and the vector vC(e_{1,c}, . . . ,e_{16,c}) 630 contains the 16 inputs X. The vector vA(e_{1,a}, . . . ,e_{16,a}) 610 has 16 1-byte elements e_{w,c} 615 each addressable using an index from 0 to F in base-16 notation, or equivalently from 00000 to 01111 in base-2 notation. The base-16 notation is used for purposes of clarity in FIG. 7 to prevent cluttering. Each element e_{w,a} 615 contains one of elements 520 from portion 550 of the look-up table 540 being looked up. Similarly, the vector vB(e_{1,b}, . . . ,e_{16,b}) 620 has 16 1-byte elements e_{w,b} 625 each addressable using an index from 10 to 1F in base-16 notation, or equivalently from 10000 to 11111 in base-2 notation. Each element e_{w,b} 625 contains one of elements 520 from portion 560 of the look-up table 540 being looked up.

For the vector vC(e_{1,c}, . . . ,e_{16,c}) 630, the 16 inputs X=x₆x₅x₄x₃x₂x₁x₀ are shown as elements e_{w,c} 635 and the 5 least significant bits x₄, x₃, x₂, x₁, x₀, which form the first set of bits, of each of the 16 inputs X=x₆x₅x₄x₃x₂x₁x₀ are used as indexes for fetching a respective element of either an element e_{w,a} 615 of vector vA(e_{1,a}, . . . ,e_{16,a}) 610 or an element e_{w,b} 625 of vector vB(e_{1,b}, . . . ,e_{16,b}) 620 resulting in the vector vD(e_{1,d}, . . . ,e_{16,d}) 640. Example values in base-16 notation for the 5 least significant bits x₄, x₃, x₂, x₁, x₀ of each of the 16 inputs X=x₆x₅x₄x₃x₂x₁x₀ are shown as A, 7, 0, 15, 5, 9, 13, 15, 2, 16, 19, 1A, A, 1F, C, 1B in elements e_{w,c} 635 of vector vC(e_{1,c}, . . . ,e_{16,c}) 630. For our specific example input, X=x₆x₅x₄x₃x₂x₁x₀=1001010 has 01010 as its 5 least significant bits, the 5 least significant bits 01010 corresponding to A in base-16 notation as shown within one of the elements e_{w,c} 635 of vector vC(e_{1,c}, . . . ,e_{16,c}) 630. During the vperm instruction, the 5 least significant bits of each input X represented as A, 7, 0, 15, 5, 9, 13, 15, 2, 16, 19, 1A, A, 1F, C, 1B in base-16 notation in elements e_{w,c} 635 of vector vC(e_{1,c}, . . . ,e_{16,c}) 630 are used to fetch a respective one of a respective element of either an element e_{w,a} 615 of vector vA(e_{1,a}, . . . ,e_{16,a}) 610 or an element e_{w,b} 625 of vector vB(e_{1,b}, . . . ,e_{16,b}) 620 resulting in the vector vD(e_{1,d}, . . . ,e_{16,d}) 640. Each element fetched is output as one of the elements e_{w,d} 645 of vector vD(e_{1,d}, . . . ,e_{16,d}) 640. For each vperm instruction, the vector vD(e_{1,d}, . . . ,e_{16,d}) 640 results in one of the groups of outputs 591, 592, 593, 594 shown in FIG. 5.

As discussed above, the outputs from the groups of outputs 591, 592, 593, 594 collectively form sets of corresponding outputs and for each input X the bit sequences 514 have common 5 least significant bits but different 2 most significant bits. For example, referring back to FIG. 6, for the specific example input with X=x₆x₅x₄x₃x₂x₁x₀=1001010, the look-ups in look-up tables 540 using the 5 least significant bits 01010 as indexes in the vperm instructions result in the outputs 506 having pre-determined values S7(x₆x₅x₄x₃x₂x₁x₀) which are functions of the bit sequences 514 having common 5 least significant bits 01010 but different 2 most significant bits. In particular, one of the pre-determined values S7 (x₆x₅x₄x₃x₂x₁x₀) of the set of corresponding outputs 506 is a function of the example input X=x₆x₅x₄x₃x₂x₁x₀=1001010.

In this specific illustrative example, at step 410, there is a total of 4 vperm instructions, and for each input X the number of possible outputs from the 128 elements 520 have been narrowed from 128 possible outputs down to 4 possible outputs.

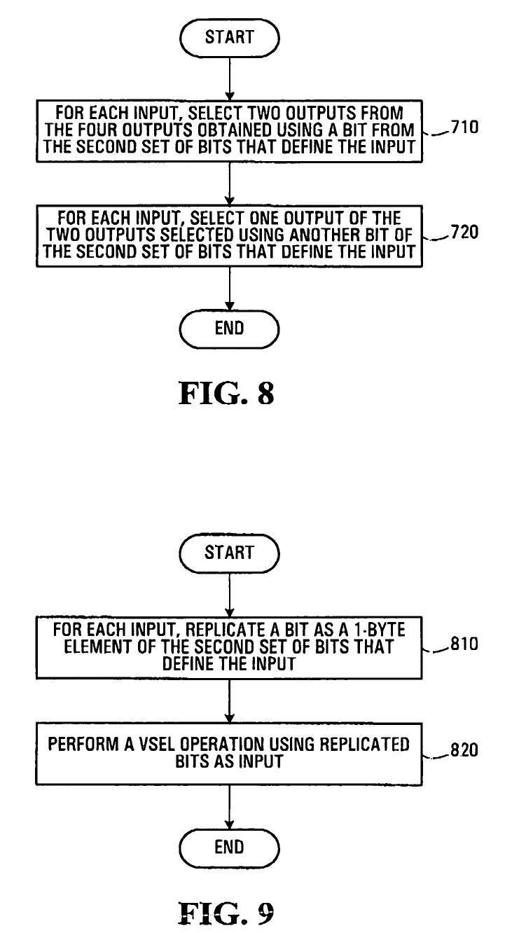

With the outputs from the groups of outputs 591, 592, 593, 594 collectively forming sets of corresponding outputs, at step 420 one corresponding output from each set of corresponding outputs is selected. For our specific example, one of the four corresponding outputs 506 is selected. The selection is made using the second set of bits x₆, x₅ that define the specific example input with X=x₆x₅x₄x₃x₂x₁x₀=1001010. In particular, the specific example input with X=x₆x₅x₄x₃x₂x₁x₀=1001010 has 10 as its second set of bits. As described in detail below with reference to FIGS. 6 and 8, the selection is performed by successively performing a selection on a remaining number of corresponding outputs for each set of corresponding outputs, wherein each time the selection is made the number of remaining corresponding outputs is halved. This selection will now be described for the illustrative example with reference to FIG. 8.

Referring to FIG. 8, shown is a flow chart of a method of performing step 420 of the method of FIG. 5. In FIG. 8 for each input X, two outputs are selected from the four outputs obtained using a bit from the second set of bits that define the input (step 710). After step 710, there are two outputs for each input X=x₆x₅x₄x₃x₂x₁x₀ and one of the outputs is selected using another bit from the second set of bits that define the input (step 720). Referring back to FIG. 6, step 710 is illustrated by the first selection 582 in which for each set of corresponding outputs one half of the corresponding outputs are selected. For example, for the specific input with X=x₆x₅x₄x₃x₂x₁x₀=1001010, of the four corresponding outputs 506 two outputs 508 are selected. Step 720 is illustrated by the second selection 583 in which for each set of remaining outputs one half of the remaining outputs is selected. For example, for the specific example input with X=x₆x₅x₄x₃x₂x₁x₀=1001010, of the remaining outputs 508, one output 511 is selected.

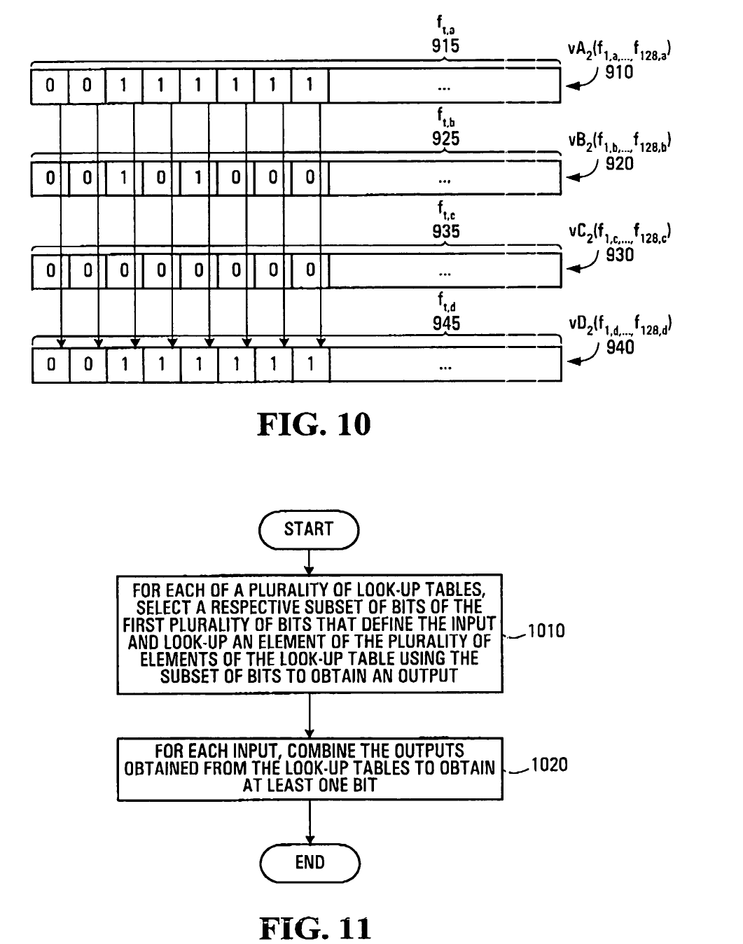

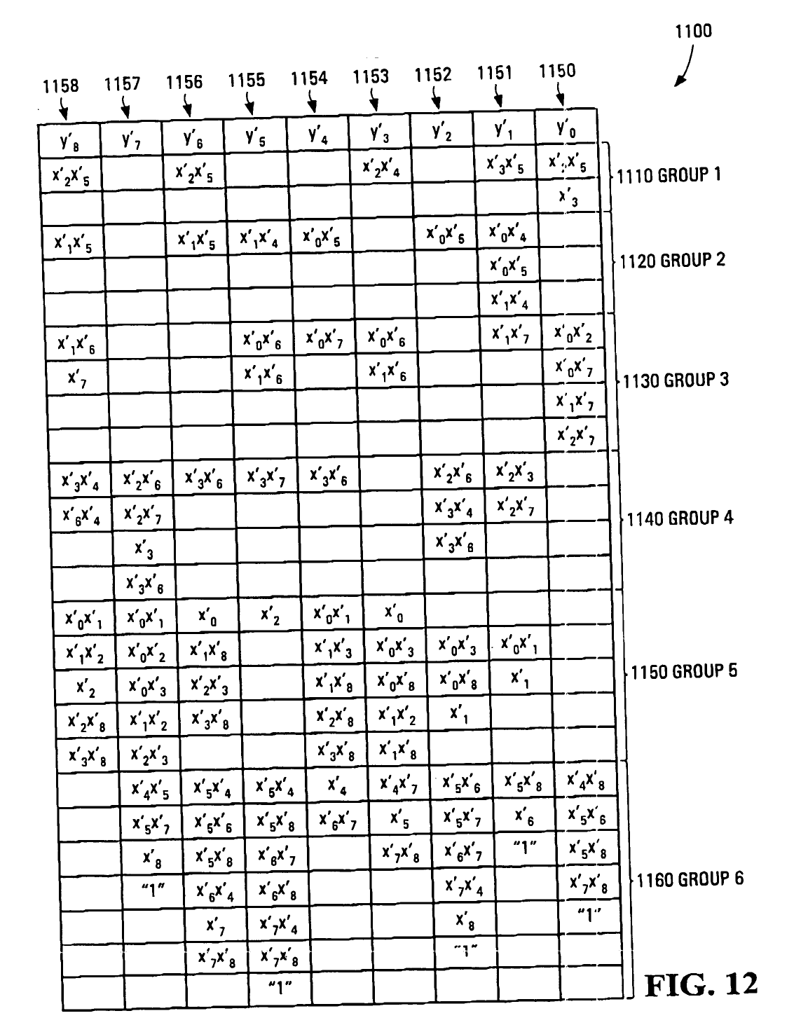

In the illustrative example, as discussed above the selection of outputs at steps 710 and 720 is performed using an Altivec vsel instruction. The vsel instruction will now be described in detail with reference to FIGS. 9 and 10.

Referring to FIG. 9, shown is flow chart of a method of selecting an output from two other outputs in the method steps 710, 720 of FIG. 8. For each input X, one of the bits of the second set of bits that define the input X is replicated as a 1-byte element (step 810) and then the vsel instruction is applied using the replicated bit of each input X (step 820). The method of FIG. 9 will now be applied to obtain the outputs 596 of FIG. 6. To obtain the group of outputs 596, at step 810 for each input X=x₆x₅x₄x₃x₂x₁x₀, the least significant bit x₅ of the second set of bits x₆, x₅ that define the input is replicated. For example, thee second set of bits x₆, x₅ of the specific example input with X=x₆x₅x₄x₃x₂x₁x₀=1001010 corresponds to 10, which has 0 as a least significant bit. As such, the bit 0 of is replicated as a 1-byte element represented as 00000000. At step 820 the vsel instruction operates on the groups of outputs 591 and 592 as vector elements using the replicated bits of each input X=x₆x₅x₄x₃x₂x₁x₀.

In particular, in FIG. 10 the vsel instruction operates on vectors vA₂(f_{1,a}, . . . ,f_{16,a}) 910 and vB₂(f_{1,b}, . . . ,f_{16,b}) 920 using vector vC₂(f_{1,c}, . . . ,f_{16,c}) 930. The vectors vA₂(f_{1,a}, . . . ,f_{16,a}) 910, vB₂(f_{1,b}, . . . , f_{16,b}) 920, and vC₂(f_{1,c}, . . . ,f_{16,c}) 930 have 128 1-bit elements f_{t,a} 915, f_{t,b} 925, and f_{t,c} 935 (t=1 to 128), respectively, (only 8 elements f_{t,a} 915, only 8 elements f_{t,b} 925, and only 8 elements f_{t,c} 935 are shown for clarity). The vector vC₂(f_{1,c}, . . . ,f_{16,c}) 930 operates on vectors vA₂(f_{1,a}, . . . ,f_{16,a}) 910 and vB₂(f_{1,b}, . . . ,f_{16,b}) 920 resulting in a vector vD₂(f_{1,d}, . . . ,f_{16,d}) 940 having 128 1-bit elements f_{t,d} 945 (only 8 elements f_{t,d} 945 are shown for clarity). In particular, for each elements f_{t,c} 935 of the vector vC₂(f_{1,c}, . . . ,f_{16,c}) 930, if the element f_{t,c} 935 contains a “0”, a corresponding element f_{t,a} 915 from the vector vA₂(f_{1,a}, . . . ,f_{16,a}) 910 is selected as an element for the vector vD₂(f_{1,d}, . . . ,f_{16,d}) 940 and if the element f_{1,c} 935 contains a “1”, a corresponding element f_{t,b} 925 from the vector vB₂(f_{1,b}, . . . ,f_{16,b}) 920 is selected as an element for the vector vD₂(f_{1,d}, . . . ,f_{16,d}) 940.

To obtain the group of outputs 596, a vsel instruction operates on the outputs 591, 592 as vectors vA₂(f_{1,a}, . . . ,f_{16,a}) 910, vB₂(f_{1,b}, . . . ,f_{16,b}) 920, respectively, using the replicated bits of each input X as elements f_{t,c} 935 of the vector Vc₂(f_{1,c}, . . . ,f_{16,c}) 930. In FIG. 10, the 8 elements f_{t,a} 915 shown as 00111111 represent the pre-determined value of the output 506 which is a function of the bit sequence 514 with 0001010 in base-2 notation. In particular, for an input corresponding to 0001010 in base-2 notation the S7 function outputs a value of 63 in base-10 notation, which corresponds to 00111111 in base-2 notation. Similarly, the 8 elements f_{t,b} 925 shown as 00101000 represent the pre-determined value of the output 506 which is a function of the bit sequence 514 with 0101010 in base-2 notation. In particular, for an input corresponding to 0101010 in base-2 notation the S7 function outputs a value of 40 in base-10 notation, which corresponds to 00101000 in base-2 notation. The 8 elements f_{t,c} 935 shown each containing “0” correspond to the replicated bit x₅=0 from the specific example input with X=x₆x₅x₄x₃x₂x₁x₀=1001010. The 8 elements f_{t,c} 935 are used to select the 8 elements f_{t,a} 915 as elements f_{t,d} 945 of the vector vD₂(f_{1,d}, . . . ,f_{16,d}) 940. The 8 elements f_{t,d} 945 shown correspond to the output 508 having associated with it the bit sequence 516 corresponding to 0001010.

The vsel instruction is also used at step 710 to obtain the group of outputs 598; however, in this case the vsel instruction operates on groups of outputs 593, 594 as vectors vA₂ (f_{1,a}, . . . ,f_{16,a}) 910 and vB₂(f_{1,b}, . . . ,f_{16,b}) 920, Respectively. Finally, the vsel instruction is used to obtain the group of outputs 599 at step 720 by operating on the group of outputs 596, 598 as vectors vA₂(f_{1,a}, . . . ,f_{16,a}) , 910 and vB₂(f_{1,b}, . . . ,f_{16,b}) 920, respectively, using replications of the most significant bit x₆ of the second set of bits x₆, x₅ of each input X=x₆x₅x₄x₃x₂x₁x₀ as vector vC₂(f_{1,c}, . . . ,f_{16,c}).

Referring back to FIG. 6, in the illustrative example the vperm instruction makes use of the 5 least significant bits x₄, x₃, x₂, x₁, x₀ of each input with X=x₆x₅x₄x₃x₂x₁x₀ as a first set of bits to look-up the look-up tables 540. The vsel instruction then makes use of the two most significant bits x₆, x₅ of each input with X=x₆x₅x₄x₃x₂x₁x₀ as a second set of bits to select outputs from the vperm instructions. Alternatively, in some embodiments of the invention the first set of bits of each input has 4 bits x₃, x₂, x₁, x₀ and the second set of bits of each input has 3 bits x₆, x₅, x₄. In such embodiments of the invention the vperm instruction looks up look-up tables of 16 elements using the first set of bits of each input X resulting in 8 corresponding outputs for each input X=x₆x₅x₄x₃x₂x₁x₀. A number Nᵥₛₑₗ=7 of vsel instructions are then used to select one of the corresponding outputs of each input X=x₆x₅x₄x₃x₂x₁x₀. In the above examples, the vperm instruction is used to look-up tables of 32 1-byte elements or tables of 16 1-byte elements; however, other implementations are possible. For example, in some implementations the vperm is used to look-up tables of 16 2-byte elements, 4 8-byte elements, or 2 16-byte elements.

Furthermore, in the embodiments of FIGS. 5 to 10, for each input with X=x₆x₅x₄x₃x₂x₁x₀, the first set of bits corresponds to least significant bits x₄, x₃, x₂, x₁, x₀ and the second set of bits corresponds to most significant bits x₆, x₅; however, the invention is not limited to such embodiments, and in other embodiments of the invention when using the vperm instruction for each input with X=x₆x₅x₄x₃x₂x₁x₀, any 4 or 5 bits of the bits xᵢ are used for the first set of bit and the remaining bits xᵢ are used for the second set of bits. This is achieved by storing the pre-determined values of the elements 520 in a different order than shown in FIG. 5.

In the illustrative example, there are four look-up tables being looked-up using vperm instructions, the four look-up tables collectively forming a larger table referred to as a super table. The number of tables a super table is divided into depends on the number of elements in the super table. In particular, in some cases the number of elements is low enough for the super table to be loaded and then looked-up using a single vperm instruction. For such cases, the method of FIG. 5 can be modified by looking up only one look-up table at step 410 and not performing step 420. As such, in some embodiments of the invention, there is a method in which for each of a plurality of inputs and in parallel with the other inputs a look-up table having a plurality of elements is looked-up using the input.

The above illustrative example has been described in the context of the S7 function of the Kasumi algorithm in which the input X_{I}=X and the output Y_{J}=Y with both X and Y each being defined by Nₓ=7 bits and N_{y}=7 bits, respectively; however, the invention is not limited to the S7 function. In some implementations operations are performed for Nₓ≧1 and N_{y}≧1. Furthermore, in the example implementation Nₓ=N_{y}; however, in other implementations Nₓ≠N_{y}. The invention is not limited to the method being applied on an architecture corresponding to a PowerPC processor having an Altivec co-processor and is also applicable to other SIMD architectures capable of implementing computations in parallel. Furthermore, a maximum for Nₓ and N_{y} is imposed only by the instructions available for performing look-ups, and in embodiments of the invention the maximum number of bits defining the output Y_{J} is imposed only by the instructions available on the architecture on which the method is applied.

Another limitation of the architecture corresponding to a PowerPC processor having an Altivec co-processor is with the use of the vperm instruction which makes use of only 4 or 5 bits of the inputs X for look-ups. However, in other embodiments of the invention for an input being defined by Nₓ bits, depending on the architecture in which the methods of FIGS. 5, 8, and 9 are applied the first set of bits of an input X has two or more bits and the second set of bits has at least one bit. Preferably, in order to allow a parallel implementation, a vector permutation operation is used. However, other processors will provide other operations, or custom operations may be defined.

Another method of using look-up tables for parallel implementations will now be discussed with reference to FIG. 10 and then as an illustrative example, the method will applied to the S9 function of the Kasumi algorithm.

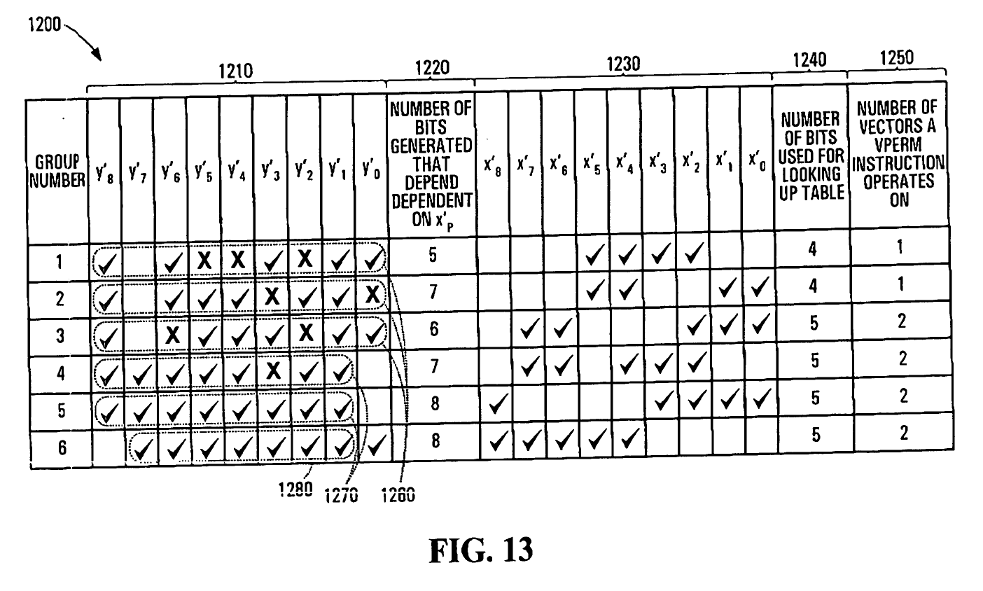

Referring to FIG. 11, shown is a flow chart of another method of performing parallel look-ups using look-up tables, according to another embodiment of the invention. The look-up tables each have a plurality of elements and are used to obtain outputs Y′_{K} from inputs X′_{L}. The method of FIG. 11 is described for one of the inputs X′_{L} only; however, the method is applied to the inputs X′_{L} in parallel. Each input X′_{L} is defined by a first plurality of bits and at step 1010, for each look-up table a subset of bits of the first plurality of bits is selected and the look-up table is looked up using the subset of bits to obtain an output. Each subset of bits contains fewer bits than the number of bits that define the input. At step 1020, the outputs are combined.

As an illustrative example, the method of FIG. 11 will now be applied to the S9 function in which X′_{L}=X′ and Y′_{K}=Y′. It is to be clearly understood that what follows is only one example implementation falling in the broad language of FIG. 11. The illustrative example will show how the method of FIG. 11 can be applied to the S9 function in a parallel implementation. However, before the method of FIG. 11 is applied to the S9 function it is worthwhile examining the S9 function in more detail.

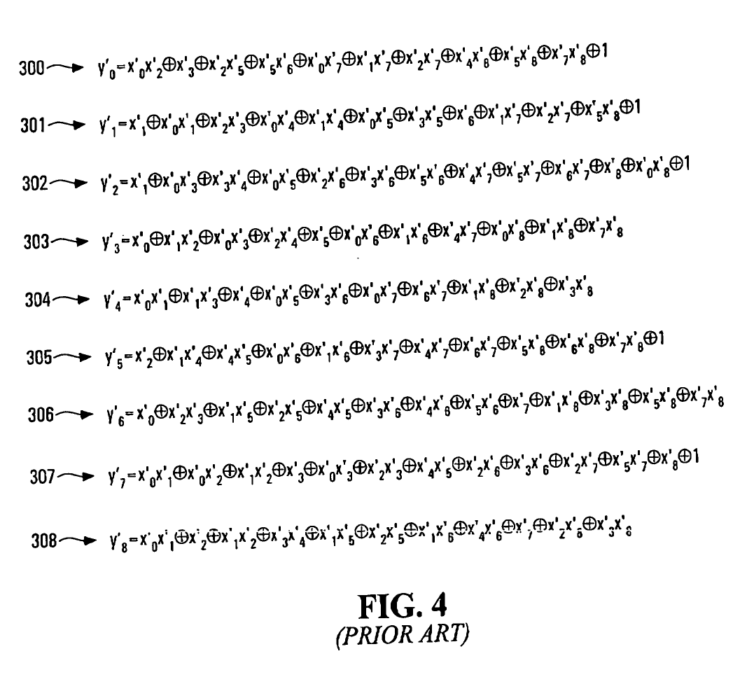

Referring back to FIG. 4, the “AND” and exclusive-OR operations of Equations 300 to 308 are both commutative and associative. As such the order of the operations in Equations 300 to 308 can be changed without affecting the result. For example, Equation 300 written as
y′₀=x′₀x′₂⊕x′₃⊕x′₂x′₅⊕x′₅x′₆⊕x′₀x′₇⊕x′₁′₇⊕x′₂x′₇⊕x′₄x′₈⊕x′₅x′₈⊕x′₇x′₈⊕1 (1)
may be re-written as
y′₀=x′₂x′₅⊕x′₃⊕x′₀x′₂⊕x′₀x′₇⊕x′₁x′₇⊕x′₂′₇⊕x′₄x′₈⊕x′₅x′₆⊕x′₅x′₈⊕x′₇x′₈⊕1 (2)
with the order of operation in which the components xₚ′x_{q}′ undergo exclusive-OR operation being changed.

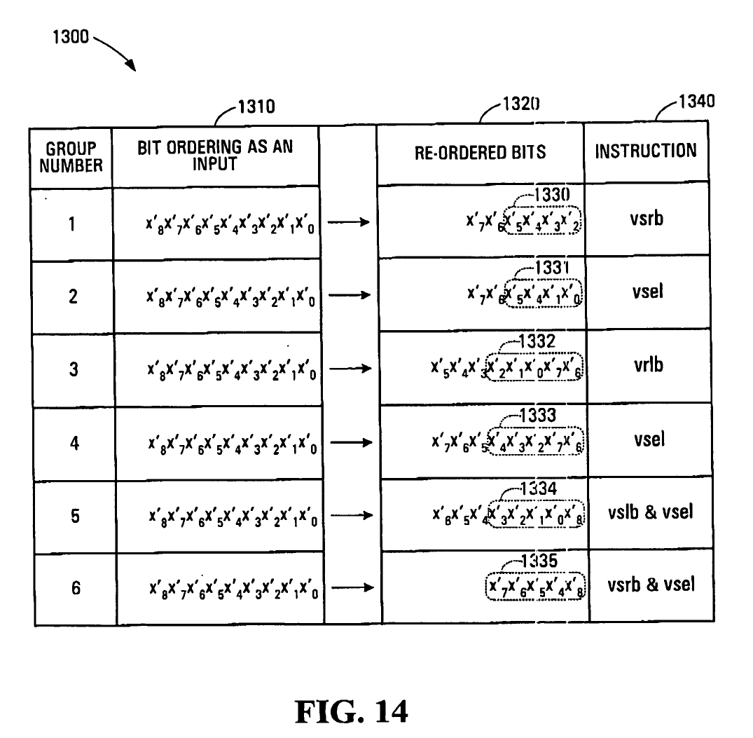

With the understanding that Equations 300 to 308 are independent of the order of operation of the components xₚ′x′_{q} x′ₚ, and “1”, the components x′ₚx′_{q}, x′ₚ, and “1” of each will now be grouped into groups for which look-up tables will be generated for implementation using the method of FIG. 11. In particular, each look-up table will be generated as a partial evaluation of the S9 function, A description of how the look-up tables are generated as partial evaluations of the S9 function will now be described with reference to FIGS. 12, 13, and 14.

Referring to FIG. 12, shown is a table generally indicated by 1100 listing into groups the components x′ₚx′_{q} of Equations 300 to 308 of FIG. 3 that are to undergo an exclusive-OR operation, in accordance with another embodiment of the invention. Columns 1150, 1151, 1152, 1153, 1154, 1155, 1156, 1157, 1158 list each component x′ₚx′_{q} of Equations 300 to 308 of FIG. 3 used for obtaining bits y′₀, y′₁, y′₂, y′₃, y′₄, y′₅, y′₆, y′₇, y′₈, respectively. In particular, “AND” operations are listed in short form as x′ₚx′_{q} representing x′ₚ∩x′_{q}. Also listed in table 1100 are components corresponding to x′ₚ and “1”. The component x′ₚ indicates that x′ₚ is to undergo an exclusive-OR operation. Similarly, the component “1” indicates that a bit corresponding to 1 is to undergo an exclusive-OR operation. The components x′ₚx′_{q}, x′ₚ, and “1” are also shown organized into groups labeled group 1 1110, group 2 1120, group 3 1130, group 4 1140, group 5 1150, group 6 1160. Each group 1 1110, group 2 1120, group 3 1130, group 4 1140, group 5 1150, group 6 1160 has at least one column 1150, 1151, 1152, 1153, 1154, 1155, 1156, 1157, 1158 in which there is no component x′ₚx′_{q}, x′ₚ, or “1”.

Recall with reference to FIG. 11, that for each of a plurality of look-up tables the look-up table is looked-up using the respective subset of bits which has fewer bits than the plurality of bits of the input X′. In order to facilitate building this look-up functionality (described below), within each group 1 1110, group 2 1120, group 3 1130, group 4 1140, group 5 1150, group 6 1160 there are 4 or 5 bits x′ₚ (out of a possible 9 input bits) which can be used to generate fill the components x′ₚx′_{q} and x′ₚ within the group. For example, within group 1 1110, bits x′₂, x′₃, x′₄, x′₅ are shown as part of the components x′ₚx′_{q}. These 4 or 5 bits of each group will be a respective subset of the 9 bit input which will be used to perform a look-up in a respective look-up table. In the example of FIG. 12, there are 6 groups thus requiring 6 look-up tables. More specifically, in the illustrative example, for each group 1 1110, group 2 1120, group 3 1130, group 1 1140, group 5 1150, group 6 1160 a respective look-up table is to be looked-up using a subset of 4 or 5 bits. For each look-up table, each bit will contribute to a respective one of 8 of 9 outputs y′₁. Only 8 of 9 outputs y′₁ are generated because each group 1 to 6 has at least one column in which there is no component.

In a preferred embodiment of the invention, the illustrative example, look-ups in look-up tables are made using the previously described vperm instruction. The vperm instruction will make use 4 or 5 bits of the 9 bits x′ₙ of the input X′ as indexes into vectors and returns a 1-byte output. Furthermore, the vperm instruction will be used to perform look-ups in look-up tables in parallel for 16 input X′. In particular, in some cases the vperm instruction will operates on one vector having 16 1-byte elements using 4 bits of the 9 bits x′ₚ of the 16 inputs X′ as indexes into the vector, and in other cases the vperm instruction will operate on two vectors each having 16 1-byte elements using 5 bits of the 9 bits x′ₚ of the 16 inputs X′ as indexes into the two vectors. Finally, at step 1020 for each for each input X′, the outputs obtained are combined to obtain the bits y′₁ of Y′.

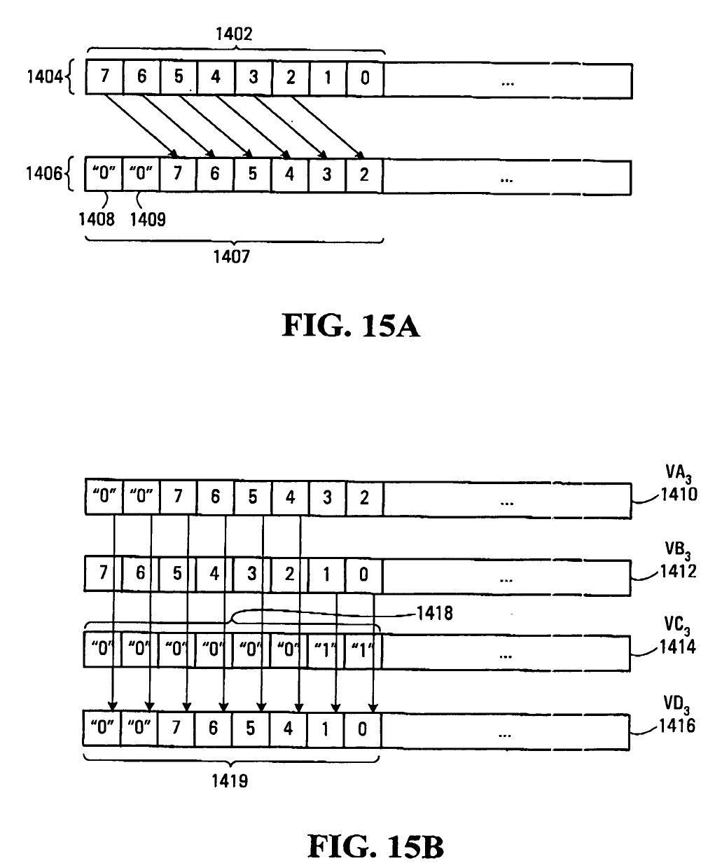

In FIG. 13, the subsets of bits selected from the bits x′ₚ to be used to look-up the look-up tables of each of groups 1 to 6 are identified by check marks in a set of columns 1230 of a table generally indicated by 1200. A number of bits x′ₚ to be used to look-up the look-up table of each group 1 to 6 is listed in a columns 1240. Recall that the vperm instruction outputs a 1-byte output and therefore, in the illustrative example, each output to be combined will have fewer bits than the 9 bits y′₁. The bits y′₁ for which outputs to be combined are determined, are shown in FIG. 13 listed in a set of columns 1210 for each of the groups 1 to 6. The check marks identify the bits y′₁ which are dependent on the subset of bit identified in the set of columns 1230; the Xs identify the bits y′₁ for which an output bit of an output to be combined is given a value of zero; and the blank spaces indicate that there is no output bit being generated. For example, for group 1 there are outputs for the bits y′₈, y′₆, y′₅, y′₄, y′₃, y′₂, y′₁, y′₀; however, for group 1 outputs for the bits y′₅, y′₄, y′₂ are not dependent on the bits x′ₚ and are set to zero. Furthermore, for group 1, there is no output bit obtained for the bit y′₇. The number of bits being generated that depend on the bits x′ₚ is shown in a column 1220 of table 1200 for each of groups 1 to 6.

Referring back to FIG. 12, each group 1 to 6 defines a set of Equations used to generate a look-up table. A description of how look-up tables are generated will now be described for group 1. In the illustrative example, for any group u (u=1 to 6) the output bits of the set of columns 1210 are expressed as y′_{v,u} (v=0 to 8). For group 1 an output to be combined is expressed as a partial output of 8 bits y′_{0,1}, y′_{1,1}, y′_{2,1}, y′_{3,1}, y′_{4,1}, y′_{5,1}, y′_{6,1}, y′_{8,1} for the bits y′₀, y′₁, y′₂, y′₃, y′₄, y′₅, y′₆, y′₈, respectively. The bits y′_{0,1}, y′_{1,1}, y′_{2,1}, y′_{3,1}, y′_{4,1}, y′_{5,1}, y′_{6,1}, y′_{8,1} are obtained from the components x′ₚx′_{q} from group 1 and are given by
y′_{0,1}=x′₂′₅⊕x′₃
y′_{1,1}=x′₃x′₅
y′_{2,2}=0
y′_{3,1}=x′₂x′₄
y′_{4,1}=0
y′_{5,1}=0
y′_{6,1}=x′₂x′₅
y′_{8,1}=x′₂x₅.

Equation (3) defines a set of Equations for generating a look-up table for group 1. In particular, in the illustrative example, the look-up table being generated has 2⁴=16 1-byte elements for the 2⁴=16 possible combinations of values for the bits x′₂, x′₃, x′₄, x′₆. Similarly, look-up tables are generated for groups 2 to 6.

Given the look-up tables for groups 1 to 6, a brief description of how outputs from the look-up tables can be obtained and then combined will now be described for bit y′₀. The brief description below will illustrate how outputs can be obtained from look-up tables and then combined. As indicated in the set of columns 1210 of table 1200, non-zero output bits for bit y′₀ are obtained from the look-up tables of groups 1, 3, and 6 and are expressed as y′_{0,1}, y′_{0,3}, y′_{0,6}, respectively,. The non-zero output bits y′_{0,1}, y′_{0,3}, y′_{0,6} are given by
y′_{0,1}=x′₂x′₅⊕x′₃
y′_{0,3}=x′₀x′₂⊕x′₀x′₇⊕x′₁x′₇⊕x′₂x′₇
y′_{0,6}=x′₄x′₈⊕x′₅x′₆⊕x′₅x′₈⊕x′₇x′₈⊕1 (4)
Combining the non-zero output bits y′_{0,1}, y′_{0,3}, y′_{0,5} using exclusive-OR operations resulting in
y′₀=y′_{0,1}⊕y′_{0,3}⊕y′_{0,6}. (5)
Equation (5) is equivalent to Equation 300 of FIG. 4 and illustrates how bits can be looked-up using a plurality of look-up tables and then combined.

In the illustrative example the method of FIG. 11 is applied to the S9 function. At step 1010, for each input X′ an output is generated for each of the look-up tables of groups 1 to 6 and the outputs are combined at step 1020. Further details of steps 1010, 1020 of the method of FIG. 10 will now be described for a PowerPC processor having an Altivec co-processor in which vperm instructions are used to look-up the look-up tables.

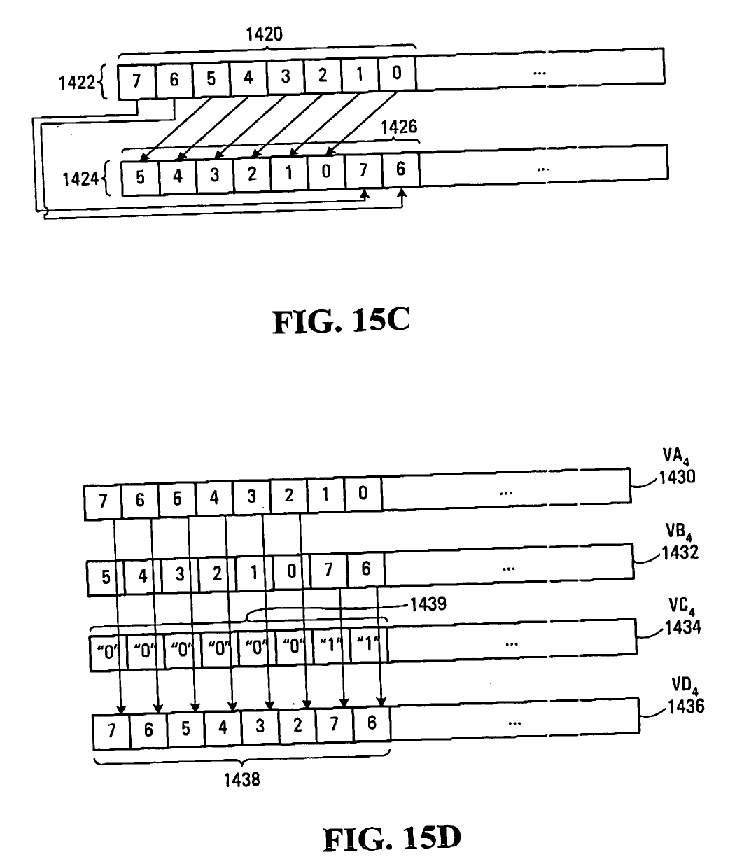

The vperm instruction makes use of the least 4 or 5 bits of an input; however, in the set of columns 1230, for each group 1 to 6 the bits x′ₚ that are to be used for looking-up a respective look-up table are not ordered as the 4 or 5 least significant bits with a left-most bit being a most significant bit and a right-most bit being a least significant bit but rather are scattered over the 9 bit input. For example, at step 1010, for group 1 the bits x′₂, x′₃, x′₄, x′₅ are to be used for looking-up a respective look-up table; however, the bits x′₂, x′₃, x′₄, x′₅ are not ordered as least significant bits of the input X′. As such, in the illustrative example at step 1010 a subset of bits of each input X′ is selected by manipulation of the bits x′ₚ so that the bits of the subset of bits are ordered as least significant bits for indexing into one or two vectors. In FIG. 14, the bits x′ₚ are shown in a column 1310 for each group 1 to 6. In a column 1320, at most eight of the nine bits x′ₚ are shown for each group 1 to 6 being re-ordered for indexing into one or two vectors. In particular, subsets of bits 1330, 1331, 1332, 1333, 1334, 1335 for which the look-up tables are looked-up for each group 1 to 6 are shown in column 1320. For example, for group 1 the subset of bits 1330 contains bits x′₅, x′₄, x′₃, x₂ being re-ordered as least significant bits. The instructions used for reordering the bits x′ₚ are listed for each group 1 to 6 in a column 1340. In particular, in the illustrative example for group 1 a vsrb (vector shift right byte) instruction is used to manipulate the bits x′ₚ: for group 2 a vsel instruction is used to manipulate the bits x′ₚ; for group 3 a vrlb (vector rotate left byte) instruction is used to re-order the bits x′ₚ; for group 4 a vsel instruction is used to manipulate the bits x′ₚ; for group 5 a combination of vslb (vector shift left byte) and vsel instructions is used to manipulate the bits x′ₚ; and for group 6 a combination of vsrb and vsel instructions is used to manipulate the bits x′ₚ. In column 1320, although the subsets of bits 1330, 1331, 1332, 1333, 1334, 1335 are ordered as least significant bits, within each subset of bits there is no specific ordering of bits required. This is because a look-up table may be pre-determined for any ordering of the bits within a subset of bits.

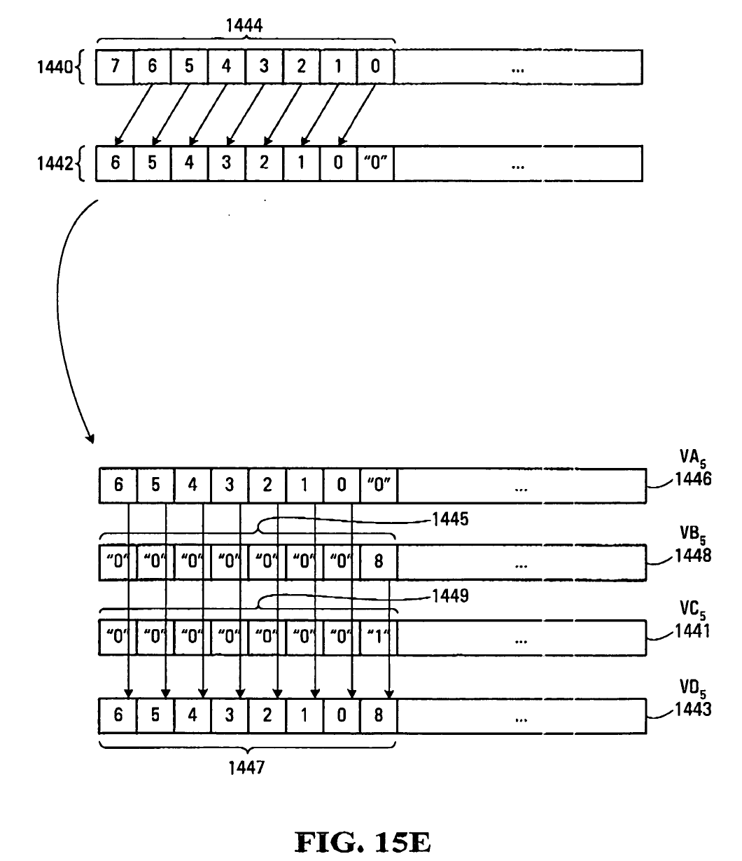

The manipulation of bits will now be described in further detail with reference to FIGS. 15A to 15F. In particular, a number of vector operations will be used to manipulate the bits of each input X′ in parallel. As discussed above, for group 1 a vsrb instruction is used to re-order the bits x′ₚ of each input X′ in parallel. For example, as shown in FIG. 15A, for group 1 the vsrb instruction operates on a vector 1404 containing 1-byte elements (only one 1-byte element 1402 is shown for clarity). Each element 1402 contains the bits x′₇, x′₆, x′⁵, x′₄, x′₃ , x′₂ x′₁, x′₀ of a respective input X′. In the elements 1402, the bits x′₇, x′₆, x′₅, x′₄, x′₃, x′₂ x′₁, x′₀ are represented by their indexes 7, 6, 5, 4, 3, 2, 1, 0, respectively. For each input X′, the vsrb instruction shifts right the bits x′₇, x′₆ , x′₅, x′₄ , x′₃, x′₂, x′₁, x′₀ by two bit units and outputs a vector 1406 containing 1-byte elements (only one 1-byte element 1407 is shown for clarity). For the vsrb instruction of FIG. 15A, each element 1407 has the bits x′₇, x′₆, x′₅, x′₄, x′₃, x′₂ represented by indexes 7, 6, 5, 4, 3, 2, respectively, as least significant bits and the bits x′₁, x′₀ of element 1402 represented by their indexes 1 and 0, respectively, are lost leaving two free most significant bits 1408 and 1409 with a zero value represented by “1”. In the element 1407, the bits x′₅, x′₄, x′₃, x′₂ of the subset of bits 1330 are ordered as least significant bits.

In FIG. 15B, for group 2 using a vsel operation the vector 1406 which is output from the vsrb instruction for group 1 is used in combination with the bits x′ₚ of each input X′ to manipulate the bits x′ₚ. In particular, the vsel instruction operates on the vectors vA₃ 1410 and vB₃ 1412 using is vector vC₃ 1414. The vector vA₃ 1410 corresponds to the vector 1406 of FIG. 15A and the vector vB₃ 1412 contains the bits x′₇, x′₆, x′₅, x′₄, x′₃, x′₂, x′₁, x′₀ of each input X′. The vector vC₃ 1414 has 16 1-byte elements (only one 1-byte element 1418 is shown for clarity) each having a constant 00000011 in base-2 notation as an entry. Each entry of the element 1418 of vector vC₃ 1414 is used to select bits from the vectors vA₃ 1410 and vB₃ 1412 resulting in a vector vD₃ 1416 having 1-byte elements (only one 1-byte element 1419 shown for clarity). The element 1419 contains two “0” bits as most significant bits and contains bits x′₇, x′₆, x′₅, x′₄, x′₁, x′₀ represented by indexes 7, 6, 5, 4, 1, 0, respectively, as least significant bits. In the element 1419, the bits x′₅, x′₄, x′₁, x′₀ of the subset of bits 1331 are ordered as least significant bits for indexing into a vector.

For group 3, a vrlb (vector rotate left byte) instruction is used to re-order the bits x′ₚ of each input X′. In FIG. 15C, a vector 1422 has 16 1-byte elements (only one 1-byte element 1420 is shown for clarity). Each element 1420 contains the bits x′₇, x′₆, x′₅, x′₄, x′₃, x′₂, x′₁, x′₀ represented by 7, 6, 5, 4, 3, 2, 1, 0, respectively, of a respective input X′. In each element 1420 the bits x′₇, x′₆, x′₅, x′₄, x′₃, x′₂, x′₁, x′₀ are rotated left by two bit units resulting in a vector 1424 having 1-byte elements (only one 1-byte element 1426 is shown for clarity) containing re-ordered input bit x′₅, x′₄, x′₃, x′₂, x′₁, x′₀, x′₇, x′₆. In each element 1426, the bits x′₂, x′₁, x′₀, x′₇, x′₆ of the subset of bits 1332 are ordered as least significant bits.

In FIG. 15D, for group 4 using a vsel operation the vector 1424 which is output from the vrlb instruction for group 3 is used in combination with the bits x′ₚ of each input X′ to manipulate the bits x′ₚ. In particular, the vsel instruction operates on vectors vA₄ 1430 and vB₄ 1432 using it vector vC₄ 1434. The vector vB₄ 1432 corresponds to the vector 1424 of FIG. 15C and the vector vA₄ 1430 contains the bits x′₇, x′₆, x′₅, x′₄, x′₃, x′₂, x′₁, x′₀ of each input X′. The vector vC₄ 1434 has 16 1-byte elements (only one 1-byte element 1439 is shown for clarity) each having a constant 00000011 in base-2 notation as an entry. Each entry of the element 1439 of vector VC₄ 1434 is used to select bits from the vectors vA₄ 1430 and vB₄ 1432 resulting in a vector vD₄ 1436 having 16 1-byte elements (only one 1-byte element 1438 is shown for clarity). Each element 1438 contains bits x′₇, x′₆, x′₅, x′₄, x′₃, x′₂, x′₇, x′₆ represented by indexes 7, 6, 5, 4, 3, 2, 7, 6, respectively, as re-ordered bits. In the element 1438, the bits x′₄, x′₃, x′₂, x′₇, x′₆ of the subset of bits 1333 are ordered as least significant bits.

For group 5, a combination of a vslb (vector shift left byte) instruction and a vsel instruction is used to obtain the subset of bits 1334. In FIG. 15E, the vslb instruction operates on a vector 1440 having 16 1-byte elements (only one 1-byte element 1444 is shown for clarity). Each elements 1444 contains bits x′₇, x′₆, x′₅, x′₄, x′₃, x′₂, x′₇, x′₀ of a respective input X′ and the vslb instruction shifts left the bits x′₇, x′₆, x′₅, x′₄, x′₃, x′₂, x′₁, x′₀ by one bit unit and outputs a vector 1442. The vsel instruction then makes use of the vector 1442. In particular, the vsel instruction operates on vectors vA₅ 1446 and vB₅ 1448. The vector vA₅ 1446 corresponds to vector 1442 obtained from the vslb instruction and the vector vB₅ 1448 contains 16 1-byte elements (only one 1-byte element 1445 is shown for clarity). Each element 1445 contains the bit x′₈ of a respective input X′. The vsel instruction operates on the vectors vA₅ 1446 and vB₅ 1448 using a vector vC₅ 1441 having 16 1-byte elements (only one 1-byte element 1449 is shown for clarity). Each element 1449 has a constant 00000001 in base-2 notation as an entry to select bits from the vectors vA₅ 1446 and vB₅ 1448 resulting in a vector vD₅ 1443 having a 1-byte element 1447 for each input X′ (only one element 1447 is shown for clarity). The element 1447 contains bits x′₆, x′₅, x′₄, x′₃, x′₂, x′₁, x′₀, x′₈ represented by indexes 6, 5, 4, 3, 2, 1, 0, 8, respectively, as re-ordered bits. In the element 1447, the bits x′₃, x′₂, x′₁, x′₀, x′₈ of the subset of bits 1334 are ordered as least significant bits.

For group 6, a combination of a vsrb instruction and a vsel instruction is used to obtain the subset of bits 1335. In FIG. 15F, the vsrb instruction operates on a vector 1450 having 16 1-byte elements (only one 1-byte element 1453 is shown for clarity). Each elements 1453 contains bits x′₇, x′₆, x′₅, x′₄, x′₃, x′₂, x′₁, x′₀ of a respective input X′ and the vsrb instruction shifts right the bits x′₇, x′₆, x′₅, x′₄, x′₃, x′₂, x′₁, x′₀, by three bit units and outputs a vector 1452. The vsel instruction then makes use of the vector 1452. In particular, the vsel instruction operates on vectors vA₆ 1454 and vB₆ 1456. The vector vA₆ 1454 corresponds to vector 1452 obtained from the vsrb instruction and the vector vB₆ 1456 contains 16 1-byte elements (only one 1-byte element 1457 is shown for clarity). Each element 1457 contains the bit x′₈ of a respective input X′. The vsel instruction operates on the vectors vA₆ 1454 and vB₆ 1456 using a vector vC₆ 1456 having 16 1-byte elements (only one 1-byte element 1549 is shown for clarity). Each element 1549 has a constant 00000001 in base-2 notation as an entry used to select bits from the vectors vA₆ 1454 and vB₆ 1458 resulting in a vector vD₆ 1451 having a 1-byte element 1455 for each input X′ (only one 1-byte element 1455 is shown for clarity). The element 1455 contains bits three null bits as most significant bits and contains bits x′₇, x′₆, x′₅, x′₄, x′₈ represented by indexes 7, 6, 5, 4, 8, respectively, as least significant re-ordered bits.

Step 1010 of FIG. 11 will now be described for group 1 of the illustrative example in which a vperm instruction is used for looking-up a look-up table. For group 1, referring back FIGS. 13 and 14 columns 1240 and 1320 indicate that for each input X′ four of the bits x′ₚ form the subset of bits 1330 are used to look-up a look-up table. As such, as indicated in a column 1250, for group 1 the vperm instruction operates on one vector having 16 1-byte elements. Similarly, for group 2 for each input X′ there are 4 of the bits x′ₚ used for looking up a look-up table and the vperm instruction operates on one vector having 16 1-byte elements as indicated in column 1250. For groups 3 to 6, for each input X′ there are 5 of the bits x′ₚ used for looking up look-up tables and the vperm instruction operates on two vectors each having 16 1-byte elements bits as indicated in column 1250.

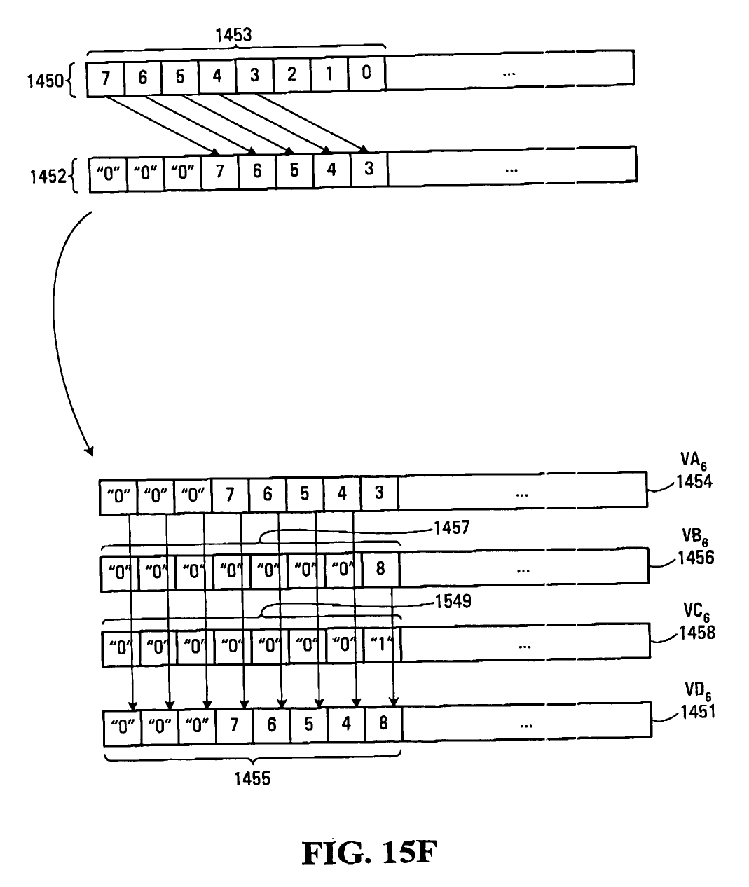

The vperm instruction will now be described with reference to FIG. 16 for a look-up for group 1 as an example. For group 1, the vperm instruction operates on a vector vA₇ 1510 using a vector vC₇ 1530. The vector vA₇ 1510 contains 16 1-byte elements (only 7 elements 1515 are shown for clarity) each containing an element of the look-up table for group 1. The vector vC₇ 1530 contains 16 1-byte elements (only 7 elements 1535 are shown for clarity) each containing the re-ordered bits x′₇, x′₆, x′₅, x′₄, x′₃, x′₂ (not shown) of a respective input X′ as indicated in column 1320 of FIG. 14. The vperm instruction makes use of the subset of bits 1330 corresponding to the 4 least significant bits x′₅, x′₄, x′₃, x′₂ to select ones of the elements 1515 to be output as an element 1545 (only 7 element 1545 are shown for clarity) of a vector vD₇ 1540. Each element 1545 of the vector vD₇ 1540 contains a 1-byte output for bits y′₈, y′₇, y′₆, y′₅, y′₄, y′₃, y′₂, y′₁, y′₀ as shown in the set of columns 1210 of FIG. 13.

For group 2, with reference to columns 1.40, 1250 of FIG. 13 the vperm instruction makes use of four bits as indexes into one vector corresponding to vector vA₇ 1510 containing elements of the look-up table for group 2. The four bits correspond to x′₅, x′₄, x′₁, x′₀ as shown by the subset of bits 1331 in column 1320 of table 1300. Each element 1545 of the vector vD₇ 1540 output by the vperm instruction contains a 1-byte output for bits y′₈, y′₇, y′₆, y′₅, y′₄, y′₃, y′₂, y′₁, y′₀ as shown in the set of columns 1210 of FIG. 13.

For group 3, as shown in columns 1240, 1250 of FIG. 13 the vperm instruction makes use of five bits as indexes into two vectors corresponding to vector vA₇ 1510 and another vector vB₇ 1520. Vectors vA₇ 1510 and vB₇ 1520 contain elements of the look-up table for group 3. The five bits correspond to x′₂, x′₁, x′₀, x′₇, x′₆ as shown by the subset of bits 1332 in column 1320 of table 1300. Each element 1545 of the vector vD₇ 1540 output by the vperm instruction contains a 1-byte output for bits y′₈, y′₆, y′₅, y′₄, y′₃, y′₂, y′₁, y′₀ as shown in the set of columns 1210 of FIG. 13.

For group 4, as shown in columns 1240, 1250 of FIG. 13 the vperm instruction makes use of five bits as indexes into the two vectors vA₇ 1510 and vB₇ 1520. In this case vectors vA₇ 1510 and vB₇ 1520 contain elements of the look-up table for group 4. The five bits correspond to x′₄, x′₃, x′₂, x′₇, x′₆ as shown by the subset of bits 1333 in column 1320 of table 1300. Each element 1545 of the vector vD₇ 1540 output by the vperm instruction contains a 1-byte output for bits y′₈, y′₇, y′₆, y′₅, y′₄, y′₃, y′₂, y′₁ as shown in the set of columns 1210 of FIG. 13.

For group 5, as shown in columns 1240, 1250 of FIG. 13 the vperm instruction makes use of five bits to look up the two vectors vA₇ 1510 and vB₇ 1520 in which the look-up table for group 5 is loaded. The five bits correspond to x′₃, x′₂, x′₁, x′₀, x′₈ as shown by the subset of bits 1334 in column 1320 of table 1300. Each element 1545 of the vector vD₇ 1540 output by the vperm instruction contains a 1-byte output for bits y′₈, y′₇, y′₆, y′₅ , y′₄, y′₃, y′₂, y′₁ as shown in the set of columns 1210 of FIG. 13.

For group 6, as shown in columns 1240, 1250 of FIG. 13 the vperm instruction makes use of five bits to look up the two vectors vA₇ 1510 and vB₇ 1520 in which the look-up table for group 6 is loaded. The five bits correspond to x′₇, x′₆, x′₅, x′₄, x′₈ as shown by the subset of bits 1335 in column 1320 of table 1300. Each element 1545 of the vector vD₇ 1540 output by the vperm instruction contains a 1-byte output for bits y′₇, y′₆, y′₅, y′₄, y′₃, y′₂, y′₁, y′₀ as shown in the set of columns 1210 of FIG. 13.

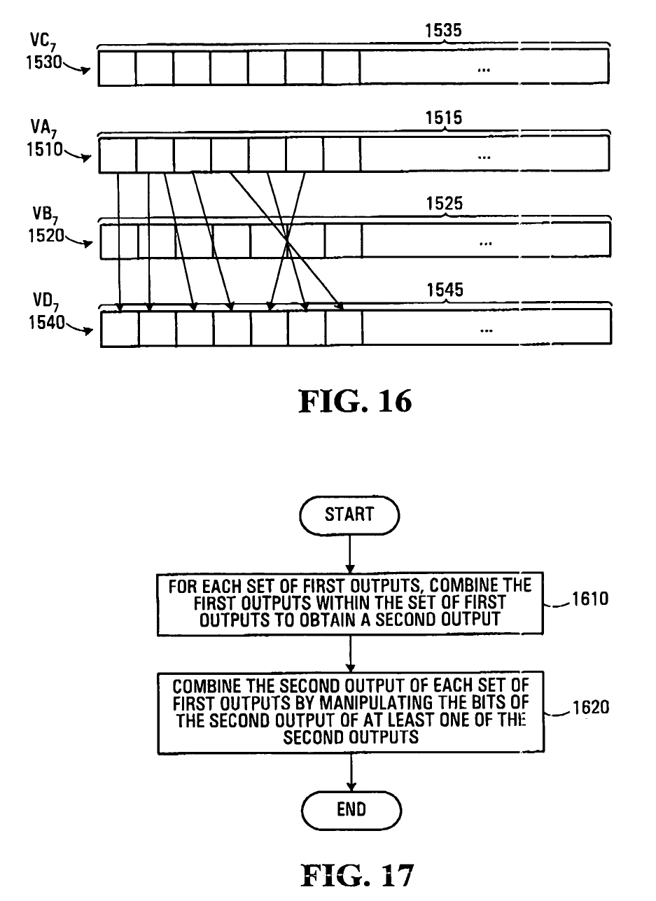

In some embodiments of the invention, for each input X′ two or more of the outputs obtained from the look-up tables form sets of first outputs. For each input X′, each set of first outputs has at least two of the outputs obtained from the look-up tables for the input X′. Referring back to FIG. 11, step 1020 will now be described with reference to FIG. 17 for embodiments in which outputs from step 1010 form such sets of first outputs. At step 1610, for an input X′ for each set of first outputs, the first outputs are combined into a second output, and at step 1620 the second outputs are combined by manipulating bits of at least one of the second outputs to produce an overall output.

The method of FIG. 17 will now be applied for the illustrative example in which outputs are obtained using vperm instructions. As shown in the set of columns 1210 of table 1200 for each group 1 to 6 there are eight output bits being generated for determination of the nine bits y′ₚ. In particular, outputs from groups 1 to 3 all have bits generated for determination of outputs bits y′₈, y′₆, y′₅, y′₄, y′₃, y′₂, y′₁, y′₀ and form a set of first outputs 1260. Similarly, outputs from groups 4 and 5 all have bits generated for determination of outputs bits y′₈, y′₇, y′₆, y′₅, y′₄, y′₃, y′₂, y′₁ and form another set of first outputs 1270. At step 1610, the first outputs 1260 are combined using exclusive-OR operations and the first outputs 1270 are also combined using exclusive-OR operations. In particular, in the illustrative example the exclusive-OR operations are applied using an Altivec vxor (vector exclusive-OR) instruction.

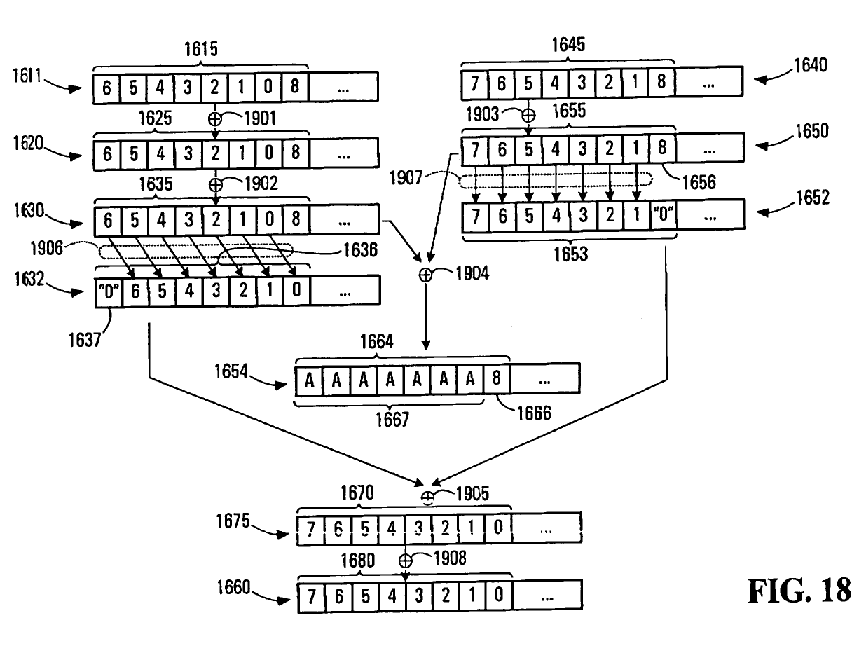

The steps of the method of FIG. 17 will now be described with reference to FIG. 18, which is a flow diagram showing how vectors containing outputs are combined by being operated on using exclusive-OR and bit manipulation operations. In particular, the flow diagram of FIG. 18 is used to illustrate the method steps of FIG. 17 in which for an input X′ for each set of first outputs, the first outputs are combined into a second output, and the second outputs are then combined by manipulating bits of at least one of the second outputs.

In FIG. 18, a vector 1611 has a 1-byte element 1615 for each input X′ (only one element 1615 is shown for clarity) with the 1-byte 1615 element containing bits from the first output 1260 of group 1. The bits from the first output 1260 of group 1 are identified as 6, 5, 4, 3, 2, 1, 0, 8 in element 1615 and are used for determination of bits y′₆, y′₅, y′₄, y′₃, y′₂, y′₁, y′₀, y′₈, respectively. A vector 1620 has a 1-byte element 1625 for each input X′ (only one element 1625 is shown for clarity) with the 1-byte 1625 element containing bits from the first output 1260 of group 2. The bits from the first output 1260 of group 2 are identified as 6, 5, 4, 3, 2, 1, 0, 8 in element 1625 and are used for determination of bits y₆′, y′₅ , y′₄, y′₃, y′₂, y′₁, y′₀, y′₈, respectively. A vector 1630 having a 1-byte element 1635 for each input X′ (only one element 1635 is shown for clarity) with the 1-byte 1635 element containing bits from the first output 1260 of group 3. The bits from the first output 1260 of group 3 are identified as 6, 5, 4, 3, 2, 1, 0, 8 in element 1615 and are used for determination of bits y′₆, y′₅, y′₄, y′₃, y′₂, y′₁, y′₀, y′₈, respectively.

For the set of first outputs 1270, a vector 1640 has a 1-byte element 1645 for each input X′ (only one element 1645 is shown for clarity) with the 1-byte 1645 element containing bits from the first output 1270 of group 4. The bits from the first output 1270 of group 4 are identified as 7, 6, 5, 4, 3, 2, 1, 8 in element 1645 and are used for determination of bits y′₇, y′₆, y′₅, y′₄, y′₃, y′₂, y′₁, y′₈, respectively. A vector 1650 has a 1-byte element 1655 for each input X′ (only one element 1655 is shown for clarity) with the 1-byte 1655 element containing bits from the first output 1270 of group 5. The bits from the first output 1270 of group 5 are identified as 7, 6, 5, 4, 3, 2, 1, 8 in element 1655 and are used for determination of bits y′₇, y′₆, y′₅, y′₄, y′₃, y′₂, y′₁, y′₈, respectively.

A vector 1654 has a 1-byte element 1664 for each input X′ which is obtained from a combination of vectors 1611, 1620, 1630, 1640, 1650 using exclusive-OR operations; 1901, 1902, 1903, 1904. In particular, the element 1664 has a bit 1666 that corresponds to a result for bit y′₈ and seven bits 1667 having entries “A” which in this case are not used.

A vector 1632 has a 1-byte element 1636 for each input X′ (only one element 1636 is shown for clarity) with a most significant bit 1637 having a zero value represented by “0”. The vector 1632 is obtained from a combination of vectors 1611, 1620, 1630 using exclusive-OR operations 1901, 1902 and from a vsrb operation 1906.

A vector 1652 has a 1-byte element 1653 for each input X′ (only one element 1653 is shown for clarity) with a bit 1658 having a zero value represented by “0”. The vector 1652 is obtained from vectors 1640 and 1650 using an exclusive-OR operation 1903 and using an Altivec vandc (vector and complement) operation 1907.

A vector 1675 has an element 1670 for each input X′ (only one element 1670 is shown for clarity). Bits within the element 1670 are identified by indexes 7, 6, 5, 4, 3, 2, 1, 0 and are used for determination of bits y′₇, y′₆, y′₅, y′₄, y′₃, y′₂, y′₁, y′₀, respectively. The vector 1675 is obtained from vectors 1632, 1652 using an exclusive-OR operation 1905.

A vector 1660 has a 1-byte element 1680 for each input X′. Each element 1680 contains a first output 1280 shown in FIG. 13 for group 6. Bits within the element 1680 are identified by indexes 7, 6, 5, 4, 3, 2, 1, 0 and are used for determination of bits y′₇, y′₆, y′₅, y′₄, y′₃, y′₂, y′₁, y′₀, respectively.

In FIG. 18, in combining the first outputs 1260 of groups 1 to 3 a first vxor instruction operates on the vectors 1611, 1620, in which corresponding bits of the sectors 1610, 1620 undergo exclusive-OR operation 1901 and results are output into the vector 1620. A second vxor instruction then operates on the vectors 1620, 1630 and corresponding bits of the vectors 1620, 1630 undergo exclusive-OR operation 1902. Results from the second vxor instruction are output as part of rector 1630 as a second output. For the first outputs 1270 of groups 4 and 5, at step 1610 a third vxor instruction operates on vector 1640, 1650, in which corresponding bits of the rectors 1640, 1650 undergo exclusive-OR operation 1903 and results are output into the vector 1650 as a second output.

A fourth vxor instruction operates the vectors 1630, 1650 containing the second outputs, and bits within the vectors 1630, 1650 undergo exclusive-OR operation 1904 the result of which is output as vector 1654. In particular, the bit 1666 of vector 1654 corresponds to a result for bit y′₈.

To obtain results for the bits y′₇, y′₆, y′₅, y′₄, y′₃, y′₂, y′₁, y′₀, the bits of elements 1635 and 1655 of vectors 1630 and 1650, respectively, are first manipulated. For example, the vsrb instruction 1906 is used to shift right by one bit unit bits of the element 1635 of each input X′ of vector 1630 resulting in vector 1632. For the vector 1650, the bit 1656 of the element 1655 of each input X′ is given a zero value for example by operating on the vector 1650 using the Altivec vandc instruction 1907 resulting in vector 1652. A fifth vxor instruction is then used to combine vectors 1632, 1652 in which bits within the vectors 1632, 1652 undergo the exclusive-OR operation 1905 to obtain vector 1675. Finally, a sixth vxor instruction operates on the vectors 1675, 1660 and bits within the vectors 1675, 1660 undergo the exclusive-OR operation 1908 the result of which is output as vector 1660. In particular, after the sixth vxor instruction each element 1680 has bits identified by indexes 7, 6, 5, 4, 3, 2, 1, 0 that correspond to results for bits y′₇, y′₆, y′₅, y′₄, y′₃, y′₂, y′₁, y′₀, respectively.

In the illustrative example at step 1010, 8 instructions are used for selecting the subsets of bits 1330, 1331, 1332, 1333, 1334, 1335 and 6 vperm instructions are used in looking up tables for groups 1 to 6. At step 1020, 8 instruction are used to obtain results for the bits y′₈, y′₇, y′₆, y′₅, y′₄ , y′₃, y′₂, y′₁, y′₀. Furthermore, in the illustrative example, steps 1010 and 1020 are performed in parallel for 16 inputs X′. As such, a total of 22 instructions are used to obtain 16 outputs Y′ resulting in an average of 14 instructions for each output Y′. Furthermore, in column 1250 of table 1200 there is a total of 10 vectors into which the look-up tables of groups 1 to 6 are loaded taking up only 10 of the 32 vectors available on a PowerPC having an Altivec co-processor. As such, the look-up tables of group 1 to 6 provide packing that not only allows the look-up tables for the S9 functions (the look-up tables of groups 1 to 6) to be loaded together into the vectors but also leaves vectors available for loading the look-up table for the S7 function into the vectors.

The illustrative example shows how the steps 1010, 1020 of FIG. 11 can be performed to produce outputs in a reduced number of instructions to provide a low demand on computing resources; however, the invention is not limited to performing the method steps 1010, 1020 of FIG. 11 as described by the illustrative example. For example, in the illustrative example as shown in FIG. 12 there are a total of six groups corresponding to groups 1 to 6 for which six look-up tables are looked up at step 1010. In other embodiments of the invention, there are more or fewer groups resulting in more or fewer look-up tables being looked-up. In addition, as shown in column 1240, for each group 1 to 6 there are 4 or 5 of the bits x′ₚ being used to look-up each table; however, this is a limitation of the vperm instruction only and in other embodiments of the invention, other instructions may be used for looking up look-up tables which require more or less than 4 or 5 of the bits x′ₚ being used to look-up each look-up table. For each group 1 to 6, the pre-determined value of the look-up table is obtained using by way of a partial evaluation of the S9 function and is a function of a number being definable by a bit sequence of one of 4 and 5 bits. However, this is a limitation of the Altivec vperm instruction only, and in other embodiments of the embodiments of the invention each pre-determined value is a function of a number being definable by a bit sequence other than 4 and 5 bits. In the illustrative, in looking-up the look-up tables the outputs from the vperm instruction have 8 bits corresponding to fewer than the 9 bits y′₁; however, embodiments of the invention are not limited to the outputs from the look-up tables having fewer bits than y′₁. For example the method of FIG. 11 is equally application to the S7 function in which case the vperm instruction is capable of outputting bits for all 7 bits yⱼ. In addition, while some embodiments of the invention are limited to combining outputs to obtain the 9 bits y′₁ in other embodiments of the invention, outputs are combined to obtain at least one bit.

In the illustrative example, the method of FIG. 11 is applied to the S9 function and the look-up tables have pre-determined values obtained from a partial evaluation of the S9 function. Furthermore, as described with reference to FIG. 18, the outputs obtained from the look-up tables are combined using exclusive-OR operations. Embodiments of the invention are not limited to the evaluation of the S9 function and other functions may be used. Furthermore, in some embodiments of the invention in which other functions are used outputs obtained from the look-up tables are combined using other operations such as addition and multiplication for example.

Regarding the set of columns 1230, specific subsets of bits of the bits x′ₚ are selected for each group 1 to 6 and in other embodiments of the invention other subsets of bits are used for looking-up tables as long as each of the bits x′ₚ is used to look-up at least one look-up table. Regarding column 1220, the number of bits generated for each groups 1 to 6 is between 5 and 8 and in other embodiments in which the evaluation of the S9 function is performed on a PowerPC processor having an Altivec co-processor, the number of bits being generated for each group defined is 8 or less; however, this limitation is imposed only by the architecture on which the method is implemented and in other embodiments of the invention, a maximum number of bits that can be generated depends on the architecture on which the method of FIG. 11 is applied. Furthermore, for each group 1 to 6 the set of columns 1210 shows specific sequences of outputs bits being generated and in other embodiments of the invention for each group defined there are other sequences of output bits. In the illustrative example in combining outputs, output bits are re-ordered; however, in some embodiments of the invention there is no re-ordering of output bits.

With reference to FIG. 14, column 1320 shows re-ordered bits for each of groups 1 to 6; however, the invention is not limited to re-ordering bits for each group defined and in other embodiments of the invention, the bits x′ₚ are re-ordered for at least one of the groups defined. The particular method of re-ordering the bits using vsrb, vsel, vclb, and vslb instructions is only one example. It is to be understood that given a set of input bits, a subset of the bits in a desired order can be generated using any suitable technique, as would be understood by one skilled in the art.

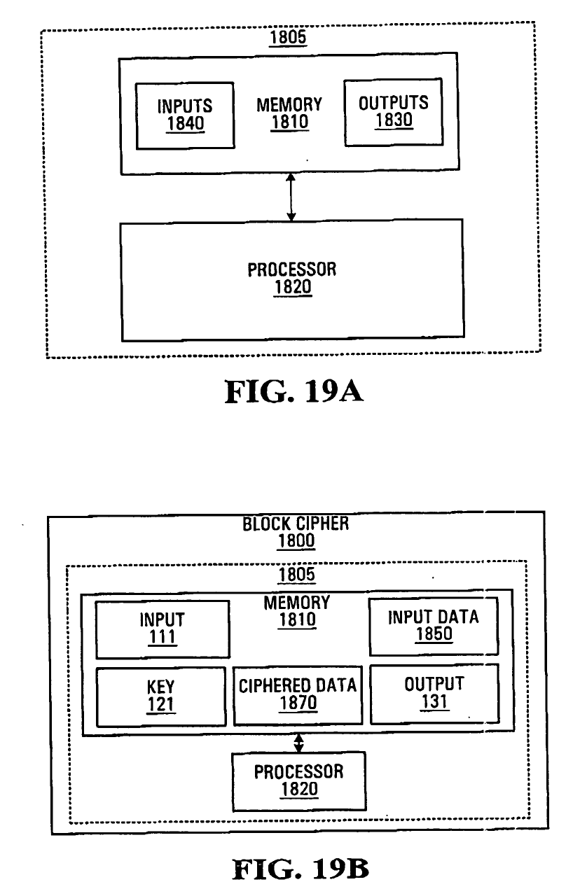

Referring to FIG. 19A, shown is a block diagram of an apparatus 1805 for implementing the methods of FIGS. 5 and 11. The apparatus 1805 has a memory 1810 and a processor 1820 having a SIMD architecture capable of accessing information stored in the memory 1810. The processor receives a plurality of inputs 1840, and performs parallel processing using the inputs 1840 to produce outputs 1830. In particular, memory 1810 stores a plurality of elements of each of a plurality of look-up tables.

In implementing the method of FIG. 5, each input 1840 is defined by a first set of bits and a second set of at least one bit. For each input 1840, the processor looks-up in the memory 1810 one element of each look-up table, for which elements are stored for the purpose of the method of FIG. 5, using the first set of bits that define the input. The look-ups result in outputs. The processor 1820 selects one of the outputs using the second set of at least one bit that define the input 1840. Processing by the processor 1820 is performed in parallel for each input 1840 resulting in outputs 1830.

In implementing the method of FIG. 11, each input 1840 is defined by a plurality of bits. For each input 1840, the processor 1820 selects a subset of bits of the plurality of bits that define the input 1840 with the bits within the subset of bits having fewer bits than the input. The processor 1820 looks-up in the memory 1810 one element from each look-up table, for which elements are stored for the purpose of the method of FIG. 11, using the subset set of bits. The look-ups result in outputs and the processor 1820 then combines the outputs. Processing by the processor 1820 is performed in parallel for sets of inputs 1840 resulting in outputs 1830.

Referring to FIG. 19B, shown is a block diagram of the apparatus 1805 of FIG. 19A implemented as a ciphering block 1800. The ciphering block 1800 contains the apparatus 1810 and operates on input data 1850. The apparatus 1805 implements the Kasumi ciphering algorithm that produces a 64-bit output 131 from a 64-bit input 111 under the control of a 128-bit key 121. The input data 1850 undergo exclusive-OR operations in parallel using the output 131 from the processor 1820 resulting in ciphered data 1870. For each input 111 and key 121 and in parallel with other inputs 111 and keys 121 (not shown), the processor 1820 implements the Kasumi algorithm in which there are eight rounds of computations. Ac each of the eight rounds the processor implements the method of FIGS. 5 and 11 to evaluate the S7 and S9 functions, respectively.

In some embodiments of the invention the ciphering apparatus is implemented at any device requiring ciphering such as an RNC (Radio Network Controller) for example.

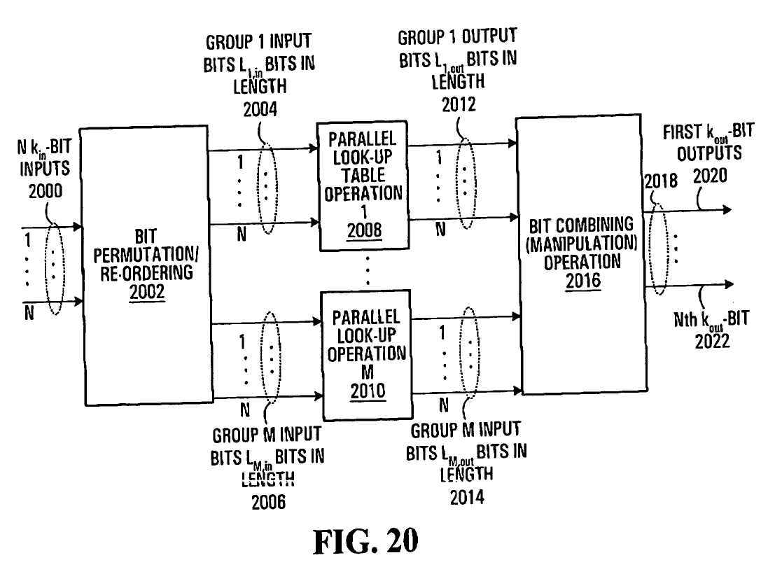

Another example implementation is illustrated in FIG. 20. There are N Kᵢₙ-bit inputs 2000 to be processed, wherein N and Kᵢₙ are integers satisfying N Kᵢₙ≧2. Bit permutation/reordering occurs at 2002 to produce M parallel sets of outputs 2004,2006 (only two shown). The ith set of outputs contains N sets of bits L_{i,in} bits in length and defines a respective subset of the input bits to be used in performing a table look-up. L_{i,in} is an integer satisfying 1≦L_{i,in}<Kᵢₙ. Thus, the first parallel set 2004 contains L_{i,in} bits for each input, and the last parallel set 2006 contains L_{M,in} bits for each input. For each parallel set of output bits 2004,2006, a parallel lookup table operation 2008,2010 is performed to generate a corresponding parallel set of outputs 2012,2014. The ith set of parallel outputs contains N outputs, one associated with each of the N inputs 2000, each of which is L_{i,out} bits in length wherein L_{i,out} is an integer satisfying L_{i,out}≧1. Thus, the first output set 2012 contains N outputs each L_{l,out} bits in length, and the last output 2014 contains N outputs each L_{M,out} in length. Finally, for each of the N inputs, a respective output is generated by performing a bit combining and in some cases bit manipulation operation on the outputs of the parallel look-up table operations 2008,2010 associated with that input. The combining operations are collectively indicated generally at 2016 and are preferably implemented in parallel. This produces outputs 2018 which include a first Kₒᵤₜ-bit output 2020 through Nth Kₒᵤₜ-bit output 2022 wherein Kₒᵤₜ is an integer satisfying Kₒᵤₜ≧1.

In preferred embodiments, the sets of bits produced by the bit permutation/reordering 2002 are selected such that each set of bits effects only some respective defined maximum number Pi<K of bits in the outputs. In this manner, each parallel look-up table operation can be implemented using a vector operation which operates in parallel on N inputs to select N Pi-bit outputs wherein Pi is an integer. If a vector operation is available which is capable of looking up K-bit values, this constraint on the bit permutation/reordering 2002 would not be necessary.

The example described previously with reference to FIGS. 12-18 is a very specific example of the implementation of FIG. 20 in which there were N=16 inputs. Different numbers of inputs can be employed. In the examples each overall input was Kᵢₙ=9 bits in length. Other lengths can be employed. In the example, there were 9 bit outputs. Other lengths can be produced. In the example, there were 6 sets of parallel outputs each of which was either 4 bits or 5 bits in length and 6 table look-up operations. Other numbers of outputs/table look-up operations can be used an(i these can have any suitable bit lengths. In the example, each output of the parallel look-up operation was 8 bits in length. Other lengths can be used.

Numerous modifications and variations of the present invention are possible in light of the above teachings. It is therefore to be understood that within the scope of the appended claims, the invention may be practised otherwise than as specifically described herein.

1. A method comprising:
responsive to a plurality of inputs, each input being defined by a first set of bits and a second set of at least one bit, for each input of the plurality of inputs and in parallel with other inputs of the plurality of inputs:
for each of a plurality of look-up tables each having a plurality of elements, looking-up one of the plurality of elements of the look-up table using the first set of bits that define the input to obtain an output, the output from each of the plurality of look-up tables collectively comprising a set of corresponding outputs; and
selecting a corresponding output from the set of corresponding outputs using the second set of a least one bit that defines the input.

2. A method according to claim 1 wherein the plurality of elements of each look-up table collectively comprise a combined table of elements each having a pre-determined value obtained using an S7 function.

3. A method according to claim 1 wherein for each look-up table, the plurality of elements of the look-up table and the plurality of inputs are loaded as vectors and the looking-up comprises for each of the inputs selecting one of the plurality of elements of the look-up table using the first set of bits that define the input.

4. A method according to claim 3 comprising using a vperm (vector permutation) instruction for the selecting one of the plurality of elements of the look-up table using the first set of bits that define the input.

5. A method according to claim 1 wherein for each of the plurality of inputs, the second set of at least one bit that defines the input comprises one bit and the set of corresponding outputs comprises two corresponding outputs, and wherein for each of the plurality of inputs the selecting comprises:
selecting one of the two outputs using the one bit of the at least one bit that defines the input.

6. A method according to claim 1 wherein for each of the plurality of inputs, the second set of at least one bit that defines the input comprises at least two bits, and wherein for each of the plurality of inputs the selecting comprises:
successively performing a selection on a remaining number of corresponding outputs of the set of corresponding outputs for each bit of the at least two bits, the number of corresponding outputs remaining being equal to all of the corresponding outputs of the set of corresponding outputs a first time the selection is performed, the selection being replacing the remaining number of corresponding outputs with a selection of half of the remaining number of outputs using a respective bit of the at least two bits, the selection of half of the remaining number of outputs being the number of remaining outputs for the next time the selection is performed.

7. A method according to claim 6 wherein for each time the selection on a remaining number of corresponding outputs is performed, the remaining number of corresponding outputs comprises at least one set of two remaining corresponding outputs and the selection of half of the remaining number of outputs comprises, for each set of two corresponding outputs of the at least one set of two remaining corresponding outputs:
replicating the respective bit into a plurality of replicated bits; and
using a vector instruction, selecting one of the two remaining corresponding outputs depending on the plurality of replicated bits.

8. A method according to claim 1 wherein the vector instruction is a vsel (vector select instruction).

9. A method according to claim 2 wherein for each input, the first set of bits that define the input comprises five bits, the second set of bits that define the input comprises two bits and the look-up tables comprise four look-up tables, wherein for each of the four look-up tables the plurality of inputs and the plurality of elements of the look-up table are loaded as vectors and the looking-up comprises for each of the inputs selecting one of the plurality of elements of the look-up table using the first set of bits that define the input.

10. A method according to claim 2 wherein for each input, the first set of bits that define the input comprises four bits, the second set of bits that define the input comprises three bits and the look-up tables comprise eight look-up tables, and wherein for each of the eight look-up tables the plurality of inputs and the plurality of elements of the look-up table are loaded as vectors and for each of the inputs the looking-up comprises selecting one of the plurality of elements of the look-up table using the first set of bits that define the input.

11. A method according to claim 2 applied in ciphering data in a Kasumi implementation.

12. An apparatus comprising:
a memory adapted to store a plurality of elements of each of a plurality of look-up tables; and
a processor adapted to:
responsive to receiving a plurality of inputs, each input being defined by a first set of bits and a second set of at least one bit, for each input of the plurality of inputs and in parallel with other inputs of the plurality of inputs:
for each of the plurality of look-up tables, look-up one of the plurality of elements of the look-up table using the first set of bits that define the input to obtain an output, the output from each of the plurality of look-up tables collectively comprising a set of corresponding outputs; and
select a corresponding output from the set of corresponding outputs using the second set of at least one bit that define the input.

13. An apparatus according to claim 12 wherein the plurality of elements of each look-up table collectively comprise a combined table of elements each having a pre-determined value obtained using an S7 function.

14. An apparatus according to claim 12 wherein for each look-up table, the plurality of elements of the look-up table and the plurality of inputs are loaded as vectors and for each of the inputs the processor is further adapted co select one of the plurality of elements of the look-up table using the first set of bits that define the input.

15. An apparatus according to claim 14 the processor comprises an Altivec co-processor having a vperm (vector permutation) instruction, the processor being adapted to use the vperm instruction for the selecting one of the plurality of elements of the look-up table using the first set of bits that define the input.

16. An apparatus according to claim 12 wherein for each of the plurality of inputs, the second set of at least one bit that defines the input comprises at least two bits, and wherein for each of the plurality of inputs in selecting the corresponding output from the set of corresponding outputs the processor is adapted to:
successively perform a selection on a remaining number of corresponding outputs of the set of corresponding outputs for each bit of the at least two bits, the number of corresponding outputs remaining being equal to all of the corresponding outputs of the set of corresponding outputs a first time the selection is performed, the selection being replacing the remaining number of corresponding outputs with a selection of half of the remaining number of outputs using a respective bit of the at least two bits, the selection of half of the remaining number of outputs being the number of remaining outputs for the next time the selection is performed.

17. An apparatus according to claim 16 wherein for each time the selection on a remaining number of corresponding outputs is performed, the remaining number of corresponding outputs comprises at least one set of two remaining corresponding outputs and the selection of half of the remaining number of outputs comprises, for each set of two corresponding outputs of the at least one set of two remaining corresponding outputs the processor being adapted to:
replicate the respective bit into a plurality of replicated bits; and
using a vector instruction, select one of the two remaining corresponding outputs depending on the plurality of replicated bits.

18. An apparatus according to claim 17 wherein the processor comprises an Altivec co-processor having a vsel (vector select instruction), the vsel instruction being the vector instruction.

19. An apparatus according to claim 13 wherein for each input, the first set of bits that define the input comprises five bits, the second set of bits that define the input comprises two bits and the look-up tables comprise four look-up tables, wherein for each of the four look-up tables the plurality of inputs and the plurality of elements of the look-up table are loaded as vectors and for each of the inputs the processor is adapted to select one of the plurality of elements of the look-up table using the first set of bits that define the input.

20. An apparatus according to claim 13 wherein for each input, the first set of bits that define the input comprises four bits, the second set of bits that define the input comprises three bits and the look-up tables comprise eight look-up tables, and wherein for each of the eight look-up tables the plurality of inputs and the plurality of elements of the look-up table are loaded as vectors and for each of the inputs the processor is adapted to select one of the plurality of elements of the look-up table using the first set of bits that define the input.

21. A method comprising:
responsive to a plurality of inputs each defined by a first plurality of bits, for each input of the plurality of inputs and in parallel with other inputs of the plurality of inputs:
for each of a plurality of look-up tables each having a plurality of elements:
selecting a respective subset of bits of the first plurality of bits that define the input, the bits of the respective subset of bits comprising fewer bits than the first plurality of bits of the input; and
looking-up an element of the plurality of elements of the look-up table using the subset of bits to obtain an output; and
combining the outputs obtained from the plurality of look-up tables to obtain at least one bit.

22. A method according to claim 21 wherein for each input of the plurality of inputs, the outputs obtained from the plurality of look-up tables each comprise a second plurality of bits, the second plurality of bits comprising fewer bits than the first plurality of bits of the input.

23. A method according to claim 22 wherein for each input of the plurality of inputs, the at least one bit comprises a third plurality of bits, the third plurality of bits comprising the same number of bits as the first plurality of bits of the input.

24. A method according to claim 21 wherein for at least one look-up table of the plurality of look-up tables, for each input the selecting comprises manipulating at least one of the plurality of bits that define the input using at least one of a bit rotation instruction and a bit shifting instruction.

25. A method according to claim 24 wherein for each of the at least one look-up table, for each input the manipulating at least one of the first plurality of bits comprises ordering the respective subset of bits of the input as least significant bits.

26. A method according to claim 23 wherein each element of the plurality of elements of each look-up table has a pre-determined value.

27. A method according to claim 26 wherein for each input of the plurality of inputs the first plurality of bits and the third plurality of bits each comprise 9 bits, the pre-determined value of each of the plurality of elements of each of the plurality of look-up tables is obtained from a partial evaluation of an S9 function.

28. A method according to claim 27 wherein for each look-up table of the plurality of look-up tables, the pre-determined value of each of the plurality of elements of the look-up table is a function of a number being definable by a b it sequence of one of 4 and 5 bits.

29. A method according to claim 28 wherein for each input of the plurality of inputs, for each look-up table the respective subset of bits of the first plurality of bits that define the input comprises one of 4 and 5 bits and the look-up table is looked-up using a vperm (vector permutation) instruction.

30. A method according to claim 27 wherein for each input of the plurality of inputs, the combining comprises performing a plurality of exclusive-OR operations on the outputs obtained from the plurality of look-up tables for the input.

31. A method according to claim 30 wherein for each input of the plurality of inputs, the combining comprises manipulating the second plurality of bits of at least one output of the outputs obtained from the plurality of look-up tables for the input using one of a bit shifting instruction and a bit rotation instruction.

32. A method according to claim 31 wherein the bit shifting instruction comprises one of a vector shift right byte instruction and a vector shift left byte instruction and the bit rotation instruction comprises one of a vector rotate left byte instruction and a vector rotate right byte instruction.

33. A method according to claim 30 wherein for each input of the plurality of inputs, the combining comprises:
for a first output of the outputs obtained from the plurality of look-up tables for the input, manipulating the second plurality of bits of the first output using one of a bit rotation instruction and a bit shifting instruction; and
for a second output of the outputs obi;aired from the plurality of look-up tables for the input, performing one of the plurality of exclusive-OR operations on the second output and the first output to obtain a third output having a fourth plurality of bits.

34. A method according to claim 30 wherein for each input, the bits of the second plurality of bits of each respective subset of bits of the first plurality of bits of the input have a pre-determined order and are each used for obtaining a respective one of the third plurality of bits, the outputs obtained from the look-up tables collectively comprising at least one group of outputs each having at least two outputs of the outputs obtained from the look-up tables, for each group of outputs of the at least one group of outputs the at least two outputs in the group of outputs having bits used for determining a common subset of bits of the third plurality of bits, the combining comprising:
for each group of outputs of the at least of group of outputs, combining the at least two outputs of i:he group of outputs using at least one of the plurality of exclusive-OR operations.

35. An apparatus comprising:
a memory adapted to store a plurality of elements of each of a plurality of look-up tables; and
a processor adapted to:
responsive to a plurality of inputs each defined by a first plurality of bits, for each input of the plurality of inputs and in parallel with other inputs of the plurality of inputs:
for each look-up table of the plurality of look-up tables:
select a respective subset of bits of then first plurality of bits that define the input, the bits of the respective subset of bits comprising fewer bits than the first plurality of bits of the input; and
look-up an element of the plurality of elements of the look-up table using the subset of bits to obtain an output; and
combine the outputs obtained from the plurality of look-up tables to obtain at least one bit.

36. An apparatus according to claim 35 wherein for each input of the plurality of inputs, the outputs obtained from the plurality of look-up tables each comprise a second plurality of bits, the second plurality of bits comprising fewer bits than the first plurality of bits of the input.

37. An apparatus according to claim 36 wherein for each input of the plurality of inputs, the at least one bit comprises a third plurality of bits, the third plurality of bits comprising the same number of bits as the first plurality of bits of the input.

38. An apparatus according to claim 35 wherein for at least one look-up table of the plurality of look-up tables, for each input the processor is adapted to manipulate at least one of the first plurality of bits that define the input using at least one of a bit rotation instruction and a bit shifting instruction.

39. An apparatus according to claim 38 wherein for each of the at least one look-up table;
for each input the processor is adapted to manipulate the at least one of the first plurality of bits by ordering the respective subset of bits of the input as least significant bits.

40. An apparatus according to claim 37 wherein each element of the plurality of elements of each look-up table has a pre-determined value.

41. An apparatus according to claim 40 wherein for each input of the plurality of inputs the first plurality of bits and the third plurality of bits each comprise 9 bits, the pre-determined value of each of the plurality of elements of each of the plurality of look-up tables is obtained from a partial evaluation of an S9 function.

42. An apparatus according to claim 41 wherein for each look-up table of the plurality of look-up tables, the pre-determined value of each of the plurality of elements of the look-up table is a function of a number being definable by a bit sequence of one of 4 and 5 bits.

43. An apparatus according to claim 42 wherein for each input of the plurality of inputs, for each look-up table the respective subset of bits of the first plurality of bits that define the input comprises one of 4 and 5 bits, the processor being adapted to look-up the look-up table using a vperm (vector permutation) instruction.

44. An apparatus according to claim 41 wherein for each input of the plurality of inputs, the processor is adapted to perform a plurality of exclusive-OR operations on the outputs obtained from the plurality of look-up tables for the input.

45. An apparatus according to claim 44 wherein for each input of the plurality of inputs, the processor is adapted to manipulate the second plurality of bits of at least one output of the outputs using one of a bit shifting instruction and bit rotation instruction.

46. A method according to claim 45 wherein the bit shifting instruction comprises one of a vector shift right byte instruction and a vector shift left byte instruction and the bit rotation instruction comprises one of a vector rotate left byte instruction and a vector rotate right byte instruction.

47. An apparatus according to claim 44 wherein for each input of the plurality of inputs, the processor is adapted to:
for a first output of the outputs obtained from the plurality of look-up tables for the input, manipulate the second plurality of bits of the first output using one of a bit rotation instruction and a bit shifting instruction; and
for a second output of the outputs obtained from the plurality of look-up tables for the input, perform one of the plurality of exclusive-OR operations on the second output and the first output to obtain a third output having a fourth plurality of bits.

48. An apparatus according to claim 44 wherein for each input, the bits of the second plurality of bits of each respective subset of bits of the first plurality of bits of the input have a pre-determined order and are each used for obtaining a respective one of the third plurality old bits, the outputs obtained from the look-up tables collectively comprising at least one group of outputs each having at least two outputs of the outputs obtained from the look-up tables, for each group of outputs of the at least one group of outputs the at least two outputs in the group of outputs having bits used for determining a common subset of bits of the third plurality of bits, the processor being adapted to:
for each group of outputs of the at least of group of outputs, combine the at least two outputs of the group of outputs using at least one of the plurality of exclusive-OR operations.

49. An article of manufacture comprising:
a computer usable medium having computer readable program code means embodied therein, the computer readable code means in said article of manufacture comprising:
responsive to a plurality of inputs, each input being defined by a first set of bits and a second set of at least one bit, for each input of the plurality of inputs and in parallel with other inputs of the plurality of inputs;
computer readable code means for, for each of a plurality of look-up tables each having a plurality of elements, looking-up one of the plurality of elements of the look-up table using the first set of bits that define the input to obtain an output, the output from each of the plurality of look-up tables collectively comprising a set of corresponding outputs; and
computer readable code means for selecting a corresponding output from the set of corresponding outputs using the second set of at least one bit that defines the input.

50. An article of manufacture comprising:
a computer usable medium having computer readable program code means embodied therein, the computer readable code means in said article of manufacture comprising:
responsive to a plurality of inputs each defined by a first plurality of bits, for each input of the plurality of inputs and in parallel with other inputs of the plurality of inputs:
computer readable code means for, for each of a plurality of look-up tables each having a plurality of elements:
selecting a respective subset of bits of the first plurality of bits that define the input, the bits of the respective subset of bits comprising fewer bits than the first plurality of bits of the input; and
looking-up an element of the plurality of elements of the look-up table using the subset of bits to obtain an output; and
computer readable code means for combining the outputs obtained from each look-up table to obtain at least one bit.

51. A method comprising:
responsive to N Kᵢₙ-bit inputs:
performing bit permutation/reordering on the N Kᵢₙ-bit inputs to produce M parallel sets of outputs wherein N and Kᵢₙ are integers satisfying N, Kᵢₙ≧2, an ith set of outputs of the M parallel sets of outputs containing N sets of bits L_{i,in} bits in length with i and L_{i,in} being integers satisfying i=1 to M and 1≧L_{i,in}<Kᵢₙ, the ith set of outputs defining a respective subset of the Kᵢₙ bits of the inputs;
for each parallel set of outputs, performing a parallel lookup table operation to generate a corresponding parallel set of outputs containing N outputs, each being associated with a respective one of the N Kᵢₙ-bit inputs and each being L_{i,out} bits in length, L_{i,out} being an integer satisfying L_{i,out}≧1; and
for each of the N Kᵢₙ-bit inputs, generating a respective output by performing a bit combining operation on the outputs from the parallel look-up table operations associated with the input.

52. A method according to claim 51 wherein for each of the N Kᵢₙ-bit inputs, the generating comprises performing a bit manipulation on the outputs of the parallel look-up table operations associated with the input.

53. A method according to claim 51 wherein the bit combining operations are implemented in parallel.

54. A method according to claim 51 wherein for each of the N Kᵢₙ-bit inputs the respective output generated comprises Kₒᵤₜ bits, Kₒᵤₜ being an integer satisfying Kₒᵤₜ≧1, and wherein in performing the bit permutation/reordering on the N Kᵢₙ-bit inputs, the ith set of outputs defining the respective subset of the Kᵢₙ bits of the inputs is selected such that the respective subset of the Kᵢₙ bits effects only a defined maximum number Pi<Kₒᵤₜ bits of the respective outputs wherein Pi is an integer.

55. A method of generating a plurality of outputs according to a ciphering algorithm which for each of the plurality of outputs operates on a respective input using a respective key, the ciphering algorithm comprising a plurality of rounds in which functions are evaluated, the method comprising, for at least one function of the functions of at least one of the plurality of rounds:
responsive to a plurality of first inputs each being associated with one of the respective inputs, for each first input and in parallel with other first inputs of the plurality of first inputs:
generating an output by looking up at least one look-up table using the input, each look-up table having a plurality of elements.

56. A method according to claim 55 wherein the ciphering algorithm is a Kasumi algorithm.

57. A method according to claim 55 wherein for a function of a certain type of the at least one function the at least one look-up table comprising a plurality of look-up tables and the output from each of the plurality of look-up tables collectively comprising a set of corresponding outputs, each first input of the plurality of first inputs being defined by a first set of bits and a second set of at least one bit, the method comprising for each first input of the plurality of first inputs and in parallel with the other first inputs of the plurality of first inputs:
selecting a corresponding output from the set of corresponding outputs using the second set of at least one bit that defines the input.

58. A method according to claim 57 wherein the ciphering algorithm is a Kasumi algorithm and the function of a certain type is an S7 function.

59. A method according to claim 55 wherein for a function of a certain type of the at least one function the at least one look-up table comprises a plurality of look-up cables and each first input of the plurality of first inputs is defined by a first plurality of bits, the method comprising:
for each first input of the plurality of first inputs and in parallel with the other first inputs of the plurality of first inputs:
for each of the plurality of look-up tables:
selecting a respective subset of bits of the first plurality of bits that define the first input, the bits of the respective subset of bits comprising fewer bits than the first plurality of bits of the first input, the look-up table being looked up using the subset of bits to obtain the output; and
combining the outputs obtained from the plurality of look-up tables to obtain at least one bit.

60. A method according to claim 59 wherein the ciphering algorithm is a Kasumi algorithm and the function of a certain type is an S9 function.

61. A method according to claim 56 wherein the at least one round comprises the plurality of rounds and wherein for each round the at least one function comprises six S7 functions and six S9 functions, the method further comprising for each function of the plurality of functions other then the at least one function:
responsive to a plurality of second inputs each being associated with one of the respective inputs, and in parallel with other second inputs of the plurality of second inputs:
generating an output according to the function using the input.

62. A method according to claim 55 further comprising, for each output of the plurality of outputs and in parallel with other outputs of the plurality of outputs:
combining the output with input data to generate ciphered data.

63. A method according to claim 62 wherein the combining comprises performing an exclusive-OR operation.

64. An apparatus for generating a plurality of outputs according to a ciphering algorithm which for each of the plurality of outputs operates on a respective input using a respective key, the ciphering algorithm comprising a plurality of rounds in which functions are evaluated, the apparatus comprising:
a memory adapted to store a plurality of elements of each of at least one look-up table; and
a processor adapted to:
for at least one function of the functions of at least one of the plurality of rounds:
responsive to a plurality of first inputs each being associated with one of the respective inputs, for each first input and in parallel with other first inputs of the plurality of first inputs:
generate an output by looking up at least one look-up table using the input, each look-up table having a plurality of elements.

65. An apparatus according to claim 64 wherein the ciphering algorithm is a Kasumi algorithm.

66. An apparatus according to claim 64 wherein for a function of a certain type of the at least one function, the at least one look-up table comprises a plurality of look-up tables and the output from each of the plurality of look-up tables collectively comprising a set of corresponding outputs, each first input of the plurality of first inputs being defined by a first set of bits and a second set of at least one bit, the processor being further adapted to:
for each first input of the plurality of first inputs and in parallel with the other first inputs of the plurality of first inputs:
select a corresponding output from the set of corresponding outputs using the second set of at least one bit that defines the input.

67. An apparatus according to claim 66 wherein the ciphering algorithm is a Kasumi algorithm and the function of a certain type is an S7 function.

68. An apparatus according to claim 64 wherein for a function of a certain type of the at least one function, the at least one look-up table comprises a plurality of look-up tables and each first input of the plurality of first inputs is defined by a first plurality of bits, the processor being further adapted to:
for each first input of the plurality of first inputs and in parallel with the other first inputs of the plurality of first inputs:
for each of the plurality of look-up tables:
select a respective subset of bits of the first plurality of bits that define the first input, the bits of the respective subset of bits comprising fewer bits than the first plurality of bits of the first input, the look-up table being looked up using the subset of bits to obtain the output; and
combine the outputs obtained from the plurality of look-up tables to obtain at least one bit.

69. An apparatus according to claim 68 wherein the ciphering algorithm is a Kasumi algorithm and the function of a certain type is an S9 function.

70. An apparatus according to claim 65 wherein the at least one round comprises the plurality of rounds and wherein for each round the at least one function comprises six S7 functions and six S9 functions, the processor being further adapted to:
for each function of the plurality of functions other than the at least one function:
responsive to a plurality of second inputs each being associated with one of the respective inputs, and in parallel with other second inputs of the plurality of second inputs:
generate an output according to the function using the input.

71. An apparatus according to claim 64 wherein the processor is further adapted to:
for each output of the plurality of outputs and in parallel with other outputs of the plurality of outputs;
combine the output with input data to generate ciphered data.

72. An apparatus according to claim 71 wherein the processor is adapted to combine the output with the input data using an exclusive-OR operation.

73. An article of manufacture comprising:
a computer usable medium having computer readable program code means embodied therein for generating a plurality of outputs according to a ciphering algorithm which for each of the plurality of outputs operates on a respective input using a respective key, the ciphering algorithm comprising a plurality of rounds in which functions are evaluated, the computer readable code means in said article of manufacture comprising:
computer readable code means for:
for at least one function of the functions of at least one of the plurality of rounds:
responsive to a plurality of first inputs each being associated with one of the respective inputs, for each first input and in parallel with other first inputs of the plurality of first inputs:
generating an output by looking up at least one look-up table using the input, each look-up table having a plurality of elements.

74. A method comprising:
responsive to a plurality of inputs, each input being defined by at least one bit, for each input of the plurality of inputs and in parallel with other inputs of the plurality of inputs:
looking-up a look-up table having a plurality of elements using the at least one bit that define the input to obtain an output.

75. An apparatus comprising:
a memory adapted to store a plurality of elements of a look-up table; and
a processor adapted to:
responsive to a plurality of inputs, each input being defined by at least one bit, for each input of the plurality of inputs and in parallel with other inputs of the plurality of inputs:
look-up the look-up table using the at least one bit that define the input to obtain an output.

76. An article of manufacture comprising:
a computer usable medium having computer readable program code means embodied therein, the computer readable code means in said article of manufacture comprising:
computer readable code means for, responsive to a plurality of inputs, each input being defined by at least one bit, for each input of the plurality of inputs and in parallel with other inputs of the plurality of inputs:
looking-up a look-up table having a plurality of elements using the at least one bit that define the input to obtain an output.
